(19) United States
(12) Patent Application Publication
(10) Pub. No.: US 2024/0048719 A1
(43) Pub. Date: Feb. 8, 2024

(54) RATE CONTROL ALGORITHMS USING A MODEL OF THE HUMAN VISUAL SYSTEM

(71) Applicant: FRAUNHOFER-GESELLSCHAFT ZUR FOERDERUNG DER ANGEWANDTEN FORSCHUNG E.V., Muenchen (DE)

(72) Inventors: Christian Helmrich, Berlin (DE); Ivan Zupancic, Berlin (DE); Benjamin Bross, Berlin (DE); Adam Wieckowski, Berlin (DE); Jonathan Pfaff, Berlin (DE); Jens Brandenburg, Berlin (DE); Heiko Schwarz, Berlin (DE); Detlev Marpe, Berlin (DE)

(21) Appl. No.: 18/379,865

(22) Filed: Oct. 13, 2023

Related U.S. Application Data
(63) Continuation of application No. PCT/EP2022/059944, filed on Apr. 13, 2022.

(30) Foreign Application Priority Data
Apr. 13, 2021 (EP) 21168230.7

(51) Int. Cl. H04N 19/147; H04N 19/172

(52) U.S. Cl. CPC H04N 19/147; H04N 19/172

(57) ABSTRACT

Apparatus for encoding a video having a sequence of frames using rate control, configured to determine a global quantization parameter for the sequence of frames based on a target bit-rate, and to perform a coding pass, coding the sequence of frames, using the global quantization parameter by determining a frame quantization parameter per frame of the sequence of frames on the basis of the global quantization parameter, and subjecting the sequence of frames to R/D optimizing encoding by using, for each frame, the frame quantization parameter determined for the respective frame so as to obtain an encoded version of an associated coding size for the respective frame.

### CROSS-REFERENCE TO RELATED APPLICATIONS

This application is a continuation of copending International Application No. PCT/EP20221059944, filed Apr. 13, 2022, which is incorporated herein by reference in its entirety, and additionally claims priority from European Application No. 21168230.7, filed Apr. 13, 2021, which is also incorporated herein by reference in its entirety.

### TECHNICAL FIELD

Embodiments according to the invention relate to apparatuses and methods for improving Rate Control (RC) Algorithms, e.g., in a Video Encoder and/or Video Decoder, using a Low-Complexity Model of the Human Visual System

### BACKGROUND OF THE INVENTION

Rate control (RC) methods play an important role in the production and distribution of compressed video content. RC solutions, which are typically implemented as single-pass or two-pass algorithms, ensure that a given input video sequence—the video material to be compressed—ends up consuming a specific number of bits (or a bit count within, say, ±1% of a specified value) after compression into a bitstream. This behavior is essential since the number of bits entailed for compression to a certain level of objective fidelity (e.g., average PSNR value) or subjective quality (e.g., mean opinion score, MOS) varies with the statistics of the input video signal's samples. In other words, RC methods, operating input adaptively, turn the inherently input dependent compression process into an input independent process in terms of resulting mean bitrate.

A number of RC algorithms have been proposed in recent years. A good overview is, e.g., provided in [1]. Moreover, a modern implementation of a two-pass RC algorithm, augmenting VVenC, an open encoder for a novel and state-of-the-art video standard called Versatile Video Coding (VVC) ([2], is published at [3]. The latter approach, in particular, encodes at a constant “average” quantization parameter (QP) of QP_{base}=32 in the first RC pass and, using some frame-wise statistics collected in this first pass and a user specified target bitrate, allocates the final number of target bits for coding each frame in the second RC pass (along with estimates of the QP for each frame, derived from each frame's target bits). Any deviations from the allocated number of bits in the second pass (caused by coding with the estimated QPs and varying frame statistics) are balanced over time by continuously updating the RC's statistical model such that the RC model becomes more “reliable” over time. Other recent rate control related publications can be found at [4]-[6].

A simple way to assess the performance of a RC algorithm in a video encoder is to specify a target bitrate that can also be obtained by encoding without RC and a certain predefined QP_{base} (see “Known Technology” section). More specifically, encodings of several video sequences with, e.g., QP_{base}=22, 27, 32, 37 may be prepared, the resulting bitrates may be collected, and comparative RC encodings may then be requested with the collected sequence-wise “fixed-QP” bitrates employed as “variable-OP” RC target rates. The closer the RC encoding results match the above-noted corresponding fixed-QP_{base}. encodings in terms of objective metrics or subjective MOS data (see also the “Introduction” section), the better. It was observed, however, that in the known technology of [1] and [3]-[6], the RC encodings, although matching the fixed-QP_{base} encodings quite well in terms of bitrate, are inferior in PSNR, XPSNR [7], SSIM or MOS, thus indicating room for improvements.

Therefore, it is desired to provide concepts for rendering picture coding and/or video coding more efficient. The objective is to improve rate control algorithms, so that a peak signal-to-noise ratio (PSNR), an extended perceptually weighted peak signal-to-noise ratio (XPSNR), a structural similarity index measure (SSIM) and/or a mean opinion score (MOS) is improved. It is desired to reduce a bit stream and thus a signalization cost.

### SUMMARY

An embodiment may have an apparatus for encoding a video having a sequence of frames using rate control, configured to determine a global quantization parameter for the sequence of frames based on a target bit-rate; perform a coding pass, coding the sequence of frames, using the global quantization parameter by determining a frame quantization parameter per frame of the sequence of frames on the basis of the global quantization parameter, and subjecting the sequence of frames to R/D optimizing encoding by using, for each frame, the frame quantization parameter determined for the respective frame so as to obtain an encoded version of an associated coding size for the respective frame.

Another embodiment may have an apparatus for detecting a scene transition in a sequence of frames, configured to determine, for each frame of the sequence of frames, a visual activity measure; and detect the scene transition based on the visual activity measure.

According to another embodiment, a method for encoding a video having a sequence of frames using rate control may have the steps of: determining a global quantization parameter for the sequence of frames based on a target bit-rate; performing a coding pass, coding the sequence of frames, using the global quantization parameter by determining a frame quantization parameter per frame of the sequence of frames on the basis of the global quantization parameter, and subjecting the sequence of frames to R/D optimizing encoding by using, for each frame, the frame quantization parameter determined for the respective frame so as to obtain an encoded version of an associated coding size for the respective frame.

According to another embodiment, a method for detecting a scene transition in a sequence of frames may have the steps of: determining, for each frame of the sequence of frames, a visual activity measure; and detecting the scene transition based on the visual activity measure.

Still another embodiment may have a non-transitory digital storage medium having stored thereon a computer program for performing a method for encoding a video having a sequence of frames using rate control, having the steps of: determining a global quantization parameter for the sequence of frames based on a target bit-rate; performing a coding pass, coding the sequence of frames, using the global quantization parameter by determining a frame quantization parameter per frame of the sequence of frames on the basis of the global quantization parameter, and subjecting the sequence of frames to R/D optimizing encoding by using, for each frame, the frame quantization parameter determined for the respective frame so as to obtain an encoded version of an associated coding size for the respective frame, when the computer program is run by a computer.

Another embodiment may have a non-transitory digital storage medium having stored thereon a computer program for performing a method for detecting a scene transition in a sequence of frames, having the steps of: determining, for each frame of the sequence of frames, a visual activity measure; and detecting the scene transition based on the visual activity measure, when the computer program is run by a computer.

Another embodiment may have a data stream generated by an inventive apparatus as mentioned above.

In accordance with a first aspect of the present invention, the inventors of the present application realized that one problem encountered when trying to use Conventional RC systems stems from the fact that they match the fixed-QP_{base} encodings quite well in terms of bitrate, but are inferior in objective or subjective performance, like PSNR, XPSNR, SSIM or MOS. According to the first aspect of the present application, this difficulty is overcome by using an adaptive quantization parameter (OP). The inventors found, that it is advantageous to adapt an ‘average’ quantization parameter for an RC coding, e.g., dependent on a target bit-rate and/or dependent on dimensions, e.g., width and height, of the frames coded with rate control, instead of using a constant/fixed ‘average’ quantization parameter for all RC codings. The ‘average’ quantization parameter, i.e. a global quantization parameter, may represent an average of all frame wise quantization parameters of a sequence of frames. It is proposed to use an adaptive quantization parameter to respond to different requirement, e.g., in terms of a target bit rate and/or in terms of the dimensions of the frames to be coded, at an RC coding. This is based on the idea that besides of maintaining a very low functional complexity, a slight speedup in the overall runtime of an RC coding can be achieved with the adaptive quantization parameter. Furthermore, an improvement of an objective and/or subjective performance of RC coding can be achieved.

Accordingly, in accordance with a first aspect of the present application, an apparatus for encoding a video having a sequence of frames using rate control (RC) is configured to determine a global quantization parameter for the sequence of frames based on a target bit-rate. The target bit-rate may indicate the target number of bits per second to be consumed by the sequence of frames. Additionally, the apparatus is configured to perform a coding pass, e.g., a first coding pass, e.g., an analysis coding pass, coding the sequence of frames, using the global quantization parameter. The coding pass may be performed by determining a frame quantization parameter per frame of the sequence of frames on the basis of the global quantization parameter. The global quantization parameter, for example, represents an average of all frame quantization parameters of the sequence of frames. Optionally, the global quantization parameter may be determined for two or more sequences of frames. Additionally, the coding pass may be performed by subjecting the sequence of frames to R/D, i.e. rate/distortion, optimizing encoding, e.g. without RC, by using, for each frame, the frame quantization parameter determined for the respective frame so as to obtain an encoded version of an associated coding size for the respective frame. In case the coding pass is performed without rate control, the rate control may be performed in a further coding pass coding the sequence of frames. The further coding pass, e.g. a second coding pass, may follow the coding pass, e.g., a first coding pass.

In accordance with an aspect of the present invention, the inventors of the present application realized that one problem encountered when trying to use Conventional RC systems stems from the fact that they are often based on a so-called A-domain paradigm. According to this aspect of the present application, this difficulty is overcome by estimating parameters for a second coding pass based on parameters of a first coding pass. The inventors found, that highly relevant compression statistics can already be obtained in a first coding pass. Therefore, it is proposed to determine, for a given frame of a sequence of frames, a second-pass quantization parameter, e.g., a further quantization parameter or a further-pass quantization parameter, based on one or more quantization parameters collected in a different RC pass, e.g., in a previous coding pass like a first coding pass, for the sequence of frames. For example, it is advantageous to determine, for a given frame of a sequence of frames, a second-pass quantization parameter based on a quantization parameters collected for the same frame in a different RC pass. Optionally, it might be advantageous to additionally base the determination of the second-pass quantization parameter of the given frame on one or more quantization parameters collected during the same pass, i.e. the second pass, for previously coded frames of the sequence of frames. The concept of considering one or more parameters of a previous coding pass for a current coding pass is based on the idea that this achieves an improvement of an RC accuracy and, thereby, stability. Furthermore, this concept exhibits a lower model complexity and/or higher objective or subjective performance.

Accordingly, in accordance with this aspect of the present application, an apparatus, e.g., the apparatus of the first aspect, for encoding a video having a sequence of frames using rate control is configured to perform a coding pass and a further coding pass coding the sequence of frames. The coding pass may be performed by determining a frame quantization parameter per frame of the sequence of frames, and by subjecting the sequence of frames to R/D optimizing encoding by using, for each frame, the frame quantization parameter determined for the respective frame so as to obtain an encoded version of an associated coding size for the respective frame. The further coding pass is performed by determining, e.g., using the herein described fourth aspect for adapting a determination function, for each frame of the sequence of frames, a further frame quantization parameter based on the frame quantization parameter determined for the respective frame in the coding pass, and based on the coding size of the respective frame obtained by the coding pass. Additionally, the further coding pass is performed by subjecting the sequence of frames to a further R/D optimizing encoding by using, for each frame, the further frame quantization parameter determined for the respective frame, thereby obtaining a coded data stream having the video encoded thereinto. The apparatus may comprise any feature and/or functionality, which is described with one or more of the other herein described apparatuses for encoding a video using RC.

In accordance with a second aspect of the present invention, the inventors of the present application realized that one problem encountered when trying to use RC systems stems from the fact that they might be suitable for typical video material, but might not be suitable for boundary-case video sequences with unusual content statistics. According to the second aspect of the present application, this difficulty is overcome by considering a visual activity measure of a frame at a coding of the frame. The inventors found, that the visual activity measure may indicate efficiently and with high accuracy whether the respective frame has an unusual content statistics, i.e., whether the frame may be associated with a high level of camera noise or film grain, a strong fine or coarse texture, a highly irregular motion, and/or a chromatic aberration. It is proposed to determine a quantization parameter for the respective frame dependent on the visual activity measure. This is based on the idea that an accuracy of the quantization parameters used for coding the respective frame can be improved and that, thereby, a deviation in the bit consumption after a final coding of the respective frame from a target bit-count allocated by the RC to that particular frame may be reduced. The visual activity measure may improve a prediction of a quantization parameter of a frame, since it corrects deficiencies in the prediction/determination occurring at frames associated with unusual content statistics. Furthermore, an improvement of an objective and/or subjective performance of RC coding can be achieved.

Accordingly, in accordance with a second aspect of the present application, an apparatus for encoding a video having a sequence of frames using rate control is configured to perform a coding pass, e.g., a first coding pass or an analysis coding pass, coding the sequence of frames, by determining a frame quantization parameter per frame of the sequence of frames, and by subjecting the sequence of frames to R/D, i.e. rate/distortion, optimizing encoding by using, for each frame, the frame quantization parameter determined for the respective frame so as to obtain an encoded version of an associated coding size for the respective frame. Additionally, the apparatus is configured to perform a further coding pass by determining, e.g., using the herein described fourth aspect for adapting a determination function, for each frame of the sequence of frames, dependent on a visual activity measure of the respective frame, a further frame quantization parameter. The determination of the further frame quantization parameter is performed based on the frame quantization parameter determined for the respective frame, e.g., in the coding pass, and based on the coding size of the respective frame obtained by the coding pass. Additionally, the apparatus is configured to perform the further coding pass by subjecting the sequence of frames to a further R/D optimizing encoding, e.g., with single loop RC which varies block QP, e.g., a delta QP; or a log rate variation along the sequentially coded frames so as to adapt the target bitrate (BR), by using, for each frame, the further frame quantization parameter determined for the respective frame, thereby obtaining a coded data stream having the video encoded thereinto.

In accordance with a third aspect of the present invention, the inventors of the present application realized that one problem encountered when trying to use RC systems stems from the fact that a typical video sequence contains relatively frequent scene changes or camera switches after which the local characteristics of the sequence usually change. According to the third aspect of the present application, this difficulty is overcome by detecting a scene transition, like a scene change or camera switch, in a sequence of frames. The inventors found, that the visual activity measure varies between two consecutive frames at a scene transition. Therefore, a scene transition can be detected efficiently and with great accuracy based on the visual activity measure. A correct detection of local changes of video content characteristics can improve a control of a coding quality and of a bitrate. Furthermore, an improvement of an objective and/or subjective performance of RC coding can be achieved, if the detection of the scene transition is implemented in one of the herein discussed apparatuses for encoding a video using RC.

Accordingly, in accordance with a third aspect of the present application, an apparatus for detecting a scene transition, e.g., a scene change or a camera switch, in a sequence of frames is configured to determine, for each frame of the sequence of frames, a visual activity measure and detect the scene transition based on the visual activity measure.

In accordance with a fourth aspect of the present invention, the inventors of the present application realized that one problem encountered when trying to use RC systems stems from the fact that a typical video sequence contains relatively frequent scene changes or camera switches after which the local characteristics of the sequence usually change. According to the fourth aspect of the present application, this difficulty is overcome by adapting a rate control parameter for each scene individually. The inventors found, that statistical models which were used in previous scenes may no longer be valid for a new scene. It is proposed to set the rate control parameter to a predetermined setting for a first frame to be encoded of a scene and adapt the rate control parameter for further frames to be encoded of the same scene, e.g., dependent on a temporal hierarchy level they are associated with. This is based on the idea that it is more efficient to consider and adapt the rate control parameter for each scene of the video individually, instead of using a rate control parameter associated with another scene of the video and gradually adapting same to the local characteristics of the new scene of the video. Furthermore, an improvement of an overall encoding performance and/or an objective performance and/or a subjective performance of the RC coding can be achieved.

Accordingly, in accordance with a fourth aspect of the present application, an apparatus for encoding a video using rate control is configured to detect scene transitions between a number of scenes in a sequence of frames, so that each frame of the sequence of frames is associated with a scene of the number of scenes, e.g., using the scene detection of the third aspect. Additionally, the apparatus is configured to encode the sequence of frames using rate control by adapting, separately for each scene, a rate control parameter for a frame of the respective scene depending on a characteristic of an encoded version of frames which precede the frame in coding order and are associated with the respective scene, and by setting, for each scene, the rate control parameter to a predetermined setting for a firstly encountered frame of the respective scene, e.g., firstly encountered in encoding order. For example, the predetermined setting might be a default setting, or might be an estimated setting estimated based on one or more frames associated with the respective scene such as based on an analysis of the visual activity measure of these frames (frames of the same scene, e.g., following the respective frame in encoding order); the predetermined setting might be determined depending on a frame coding type and/or a temporal hierarchy level, e.g., temporal layer, of the respective frame.

Embodiments are related to methods, which are based on the same considerations as the above-described apparatuses. The methods can, by the way, be completed with all features and functionalities, which are also described with regard to the apparatuses.

An embodiment is related to a data stream having a picture or a video encoded thereinto by an apparatus for encoding a video. Another embodiment is related to a data stream having a picture or a video encoded thereinto using a herein described method for encoding the video.

An embodiment is related to a computer program having a program code for performing, when running on a computer, a herein described method, when being executed on the computer.

### BRIEF DESCRIPTION OF THE DRAWINGS

The drawings are not necessarily to scale, emphasis instead generally being placed upon illustrating the principles of the invention. In the following description, various embodiments of the invention are described with reference to the following drawings, in which:

FIG. 1 shows an embodiment of an encoding into a data stream;

FIG. 2 shows an embodiment of an encoder;

FIG. 3 shows an embodiment of a reconstruction of a picture;

FIG. 4 shows an embodiment of a decoder;

FIG. 5 shows an embodiment of an encoder configured to determine a global QP dependent on input;

FIG. 6 shows an embodiment of an encoder configured to determine a frame QP dependent on a visual activity measure;

FIG. 7 shows a sequence of frames grouped into temporal levels;

FIG. 8 shows an embodiment of an apparatus for detecting a scene transition;

FIG. 9 shows an embodiment of an encoder configured to adapt a rate control parameter individually for each scene of a video;

FIG. 10 shows an encoding order and a display order of a sequence of frames;

FIG. 11 shows an embodiment of a method comprising determining a global OP dependent on input;

FIG. 12 shows an embodiment of a method comprising determining a frame QP dependent on a visual activity measure;

FIG. 13 shows an embodiment of a method for detecting a scene transition; and

FIG. 14 shows an embodiment of a method configured to adapt a rate control parameter individually for each scene of a video.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

In the following, various examples are described which may assist in achieving a more effective compression and an improved encoding performance when using RC encoding. The RC encoding may be added to other encoding modes heuristically designed, for instance, or may be provided exclusively.

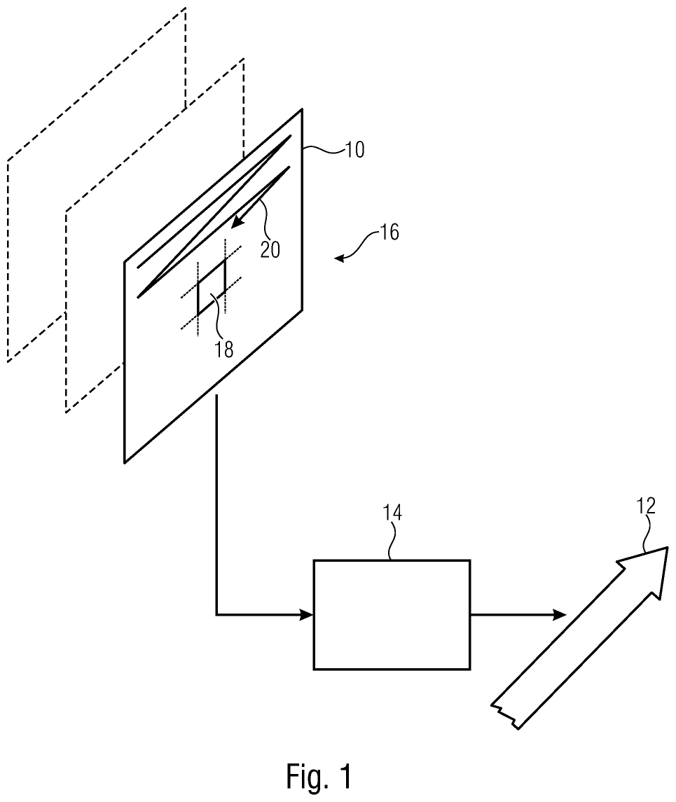

In order to ease the understanding of the following examples of the present application, the description starts with a presentation of possible encoders and decoders fitting thereto into which the subsequently outlined examples of the present application could be built. FIG. 1 shows an apparatus for block-wise encoding a picture 10 into a datastream 12. The apparatus is indicated using reference sign 14 and may be a still picture encoder or a video encoder. In other words, picture 10 may be a current picture out of a video 16 when the encoder 14 is configured to encode video 16 including picture 10 into datastream 12, or encoder 14 may encode picture 10 into datastream 12 exclusively.

As mentioned, encoder 14 performs the encoding in a block-wise manner or block-base. To this, encoder 14 subdivides picture 10 into blocks, units of which encoder 14 encodes picture 10 into datastream 12. Generally, the subdivision may end-up into blocks 18 of constant size such as an array of blocks arranged in rows and columns or into blocks 18 of different block sizes such as by use of a hierarchical multi-tree subdivisioning with starting the multi-tree subdivisioning from the whole picture area of picture 10 or from a pre-partitioning of picture 10 into an array of tree blocks wherein these examples shall not be treated as excluding other possible ways of subdivisioning picture 10 into blocks 18.

Further, encoder 14 is a predictive encoder configured to predictively encode picture 10 into datastream 12. For a certain block 18 this means that encoder 14 determines a prediction signal for block 18 and encodes the prediction residual, i.e. the prediction error at which the prediction signal deviates from the actual picture content within block 18, into datastream 12.

Encoder 14 may support different prediction modes so as to derive the prediction signal for a certain block 18. The prediction modes comprise intra-prediction modes according to which the inner of block 18 is predicted spatially from neighboring, already encoded samples of picture 10. The encoding of picture 10 into datastream 12 and, accordingly, the corresponding decoding procedure, may be based on a certain coding order 20 defined among blocks 18. For instance, the coding order 20 may traverse blocks 18 in a raster scan order such as row-wise from top to bottom with traversing each row from left to right, for instance. In case of hierarchical multi-tree based subdivisioning, raster scan ordering may be applied within each hierarchy level, wherein a depth-first traversal order may be applied, i.e. leaf notes within a block of a certain hierarchy level may precede blocks of the same hierarchy level having the same parent block according to coding order 20. Depending on the coding order 20, neighboring, already encoded samples of a block 18 may be located usually at one or more sides of block 18. For instance, neighboring, already encoded samples of a block 18 are located to the top of, and to the left of block 18.

Intra-prediction modes may not be the only ones supported by encoder 14. In case of encoder 14 being a video encoder, for instance, encoder 14 may also support intra-prediction modes according to which a block 18 is temporarily predicted from a previously encoded picture of video 16. Such an intra-prediction mode may be a motion-compensated prediction mode according to which a motion vector is signaled for such a block 18 indicating a relative spatial offset of the portion from which the prediction signal of block 18 is to be derived as a copy. Additionally or alternatively, other non-intra-prediction modes may be available as well such as inter-view prediction modes in case of encoder 14 being a multi-view encoder, or non-predictive modes according to which the inner of block 18 is coded as is, i.e. without any prediction.

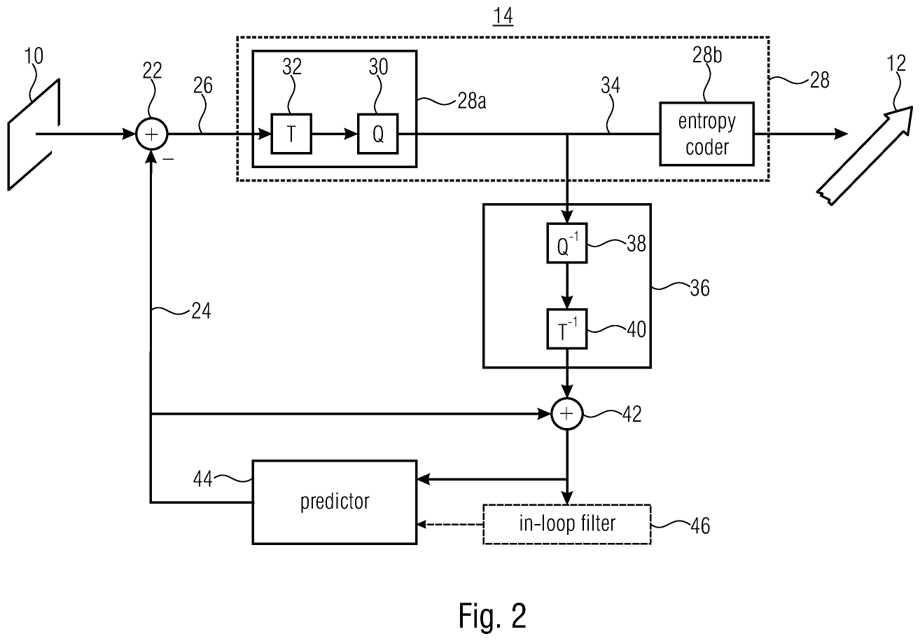

FIG. 2 shows a possible implementation of encoder 14 of FIG. 1, namely one where the encoder is configured to use transform coding for encoding the prediction residual although this is nearly an example and the present application is not restricted to that sort of prediction residual coding. According to FIG. 2, encoder 14 comprises a subtractor 22 configured to subtract from the inbound signal, i.e. picture 10 or, on a block basis, current block 18, the corresponding prediction signal 24 so as to obtain the prediction residual signal 26 which is then encoded by a prediction residual encoder 28 into a datastream 12. The prediction residual encoder 28 is composed of a lossy encoding stage 28a and a lossless encoding stage 28b. The lossy stage 28a receives the prediction residual signal 26 and comprises a quantizer 30 which quantizes the samples of the prediction residual signal 26. As already mentioned above, the present example uses transform coding of the prediction residual signal 26 and accordingly, the lossy encoding stage 28a comprises a transform stage 32 connected between subtractor 22 and quantizer 30 so as to transform such a spectrally decomposed prediction residual 26 with a quantization of quantizer 30 taking place on the transformed coefficients where presenting the residual signal 26. The transform may be a DCT, DST, FFT, Hadamard transform or the like. The transformed and quantized prediction residual signal 34 is then subject to lossless coding by the lossless encoding stage 28b which is an entropy coder entropy coding quantized prediction residual signal 34 into datastream 12. Encoder 14 further comprises the prediction residual signal reconstruction stage 36 connected to the output of quantizer 30 so as to reconstruct from the transformed and quantized prediction residual signal 34 the prediction residual signal in a manner also available at the decoder, i.e. taking the coding loss is quantizer 30 into account. To this end, the prediction residual reconstruction stage 36 comprises a dequantizer 38 which perform the inverse of the quantization of quantizer 30, followed by an inverse transformer 40 which performs the inverse transformation relative to the transformation performed by transformer 32 such as the inverse of the spectral decomposition such as the inverse to any of the above-mentioned specific transformation examples. Encoder 14 comprises an adder 42 which adds the reconstructed prediction residual signal as output by inverse transformer 40 and the prediction signal 24 so as to output a reconstructed signal, i.e. reconstructed samples. This output is fed into a predictor 44 of encoder 14 which then determines the prediction signal 24 based thereon. It is predictor 44 which supports all the prediction modes already discussed above with respect to FIG. 1. FIG. 2 also illustrates that in case of encoder 14 being a video encoder, encoder 14 may also comprise an in-loop filter 46 with filters completely reconstructed pictures which, after having been filtered, form reference pictures for predictor 44 with respect to inter-predicted block.

As already mentioned above, encoder 14 operates block-based. For the subsequent description, the block bases of interest is the one subdividing picture 10 into blocks for which the intra-prediction mode is selected out of a set or plurality of intra-prediction modes supported by predictor 44 or encoder 14, respectively, and the selected intra-prediction mode performed individually. Other sorts of blocks into which picture 10 is subdivided may, however, exist as well. For instance, the above-mentioned decision whether picture 10 is inter-coded or intra-coded may be done at a granularity or in units of blocks deviating from blocks 18. For instance, the inter/intra mode decision may be performed at a level of coding blocks into which picture 10 is subdivided, and each coding block is subdivided into prediction blocks. Prediction blocks with encoding blocks for which it has been decided that intra-prediction is used, are each subdivided to an intra-prediction mode decision. To this, for each of these prediction blocks, it is decided as to which supported intra-prediction mode should be used for the respective prediction block. These prediction blocks will form blocks 18 which are of interest here. Prediction blocks within coding blocks associated with inter-prediction would be treated differently by predictor 44. They would be inter-predicted from reference pictures by determining a motion vector and copying the prediction signal for this block from a location in the reference picture pointed to by the motion vector. Another block subdivisioning pertains the subdivisioning into transform blocks at units of which the transformations by transformer 32 and inverse transformer 40 are performed. Transformed blocks may, for instance, be the result of further subdivisioning coding blocks. Naturally, the examples set out herein should not be treated as being limiting and other examples exist as well. For the sake of completeness only, it is noted that the subdivisioning into coding blocks may, for instance, use multi-tree subdivisioning, and prediction blocks and/or transform blocks may be obtained by further subdividing coding blocks using multi-tree subdivisioning, as well.

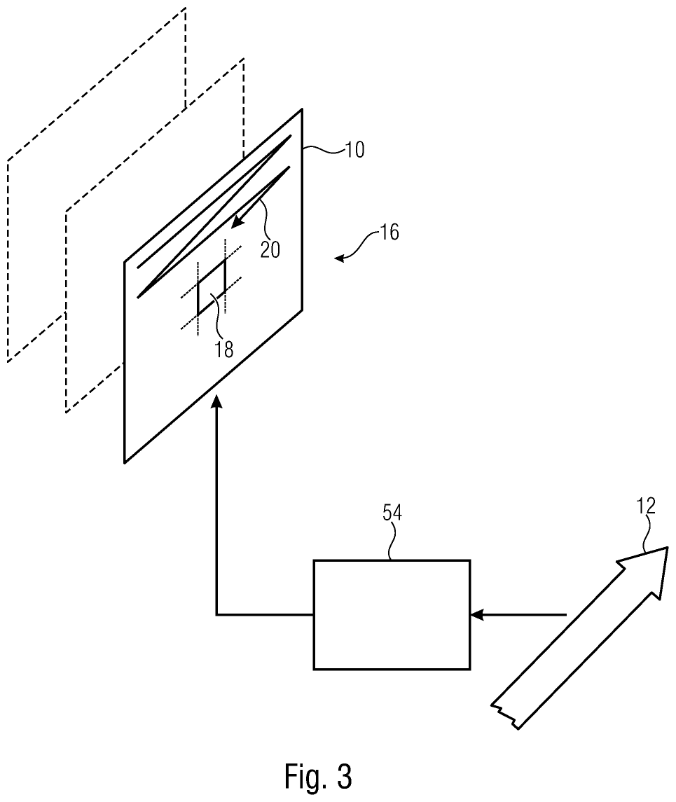

A decoder 54 or apparatus for block-wise decoding fitting to the encoder 14 of FIG. 1 is depicted in FIG. 3. This decoder 54 does the opposite of encoder 14, i.e. it decodes from datastream 12 picture 10 in a block-wise manner and supports, to this end, a plurality of intra-prediction modes. The decoder 54 may comprise a residual provider 156, for example. All the other possibilities discussed above with respect to FIG. 1 are valid for the decoder 54, too. To this, decoder 54 may be a still picture decoder or a video decoder and all the prediction modes and prediction possibilities are supported by decoder 54 as well. The difference between encoder 14 and decoder 54 lies, primarily, in the fact that encoder 14 chooses or selects coding decisions according to some optimization such as, for instance, in order to minimize some cost function which may depend on coding rate and/or coding distortion. One of these coding options or coding parameters may involve a selection of the intra-prediction mode to be used for a current block 18 among available or supported intra-prediction modes. The selected intra-prediction mode may then be signaled by encoder 14 for current block 18 within datastream 12 with decoder 54 redoing the selection using this signalization in datastream 12 for block 18. Likewise, the subdivisioning of picture 10 into blocks 18 may be subject to optimization within encoder 14 and corresponding subdivision information may be conveyed within datastream 12 with decoder 54 recovering the subdivision of picture 10 into blocks 18 on the basis of the subdivision information. Summarizing the above, decoder 54 may be a predictive decoder operating on a block-bases and besides intra-prediction modes, decoder 54 may support other prediction modes such as inter-prediction modes in case of, for instance, decoder 54 being a video decoder. In decoding, decoder 54 may also use the coding order 20 discussed with respect to FIG. 1 and as this coding order 20 is obeyed both at encoder 14 and decoder 54, the same neighboring samples are available for a current block 18 both at encoder 14 and decoder 54. Accordingly, in order to avoid unnecessary repetition, the description of the mode of operation of encoder 14 shall also apply to decoder 54 as far the subdivision of picture 10 into blocks is concerned, for instance, as far as prediction is concerned and as far as the coding of the prediction residual is concerned. Differences lie in the fact that encoder 14 chooses, by optimization, some coding options or coding parameters and signals within, or inserts into, datastream 12 the coding parameters which are then derived from the datastream 12 by decoder 54 so as to redo the prediction, subdivision and so forth.

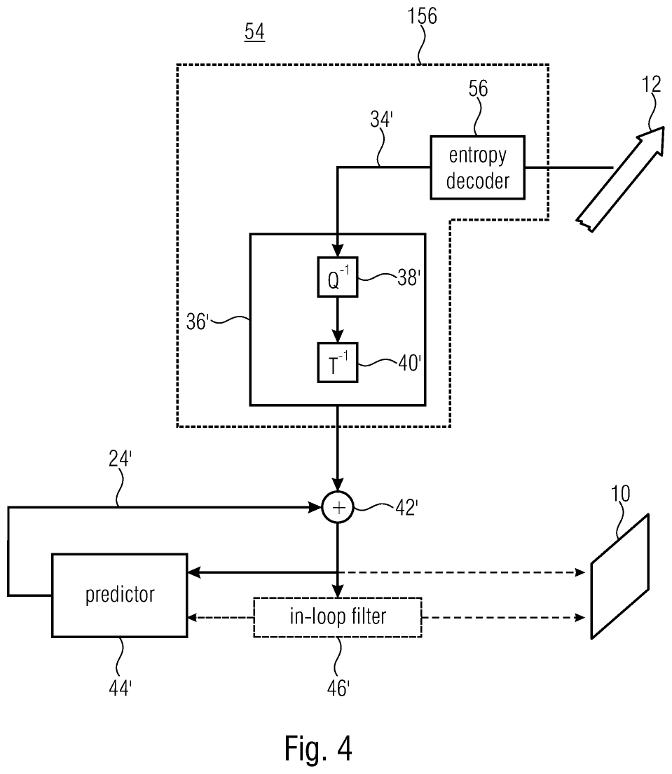

FIG. 4 shows a possible implementation of the decoder 54 of FIG. 3, namely one fitting to the implementation of encoder 14 of FIG. 1 as shown in FIG. 2. As many elements of the encoder 54 of FIG. 4 are the same as those occurring in the corresponding encoder of FIG. 2, the same reference signs, provided with an apostrophe, are used in FIG. 4 in order to indicate these elements. In particular, adder 42′, optional in-loop filter 46′ and predictor 44′ are connected into a prediction loop in the same manner that they are in encoder of FIG. 2. The reconstructed, i.e. dequantized and retransformed prediction residual signal applied to added 42′ is derived by a sequence of entropy decoder 56 which inverses the entropy encoding of entropy encoder 28b, followed by the residual signal reconstruction stage 36′ which is composed of dequantizer 38′ and inverse transformer 40′ just as it is the case on encoding side. The decoder's output is the reconstruction of picture 10. The reconstruction of picture 10 may be available directly at the output of adder 42′ or, alternatively, at the output of in-loop filter 46′. Some post-filter may be arranged at the decoder's output in order to subject the reconstruction of picture 10 to some post-filtering in order to improve the picture quality, but this option is not depicted in FIG. 4.

Again, with respect to FIG. 4 the description brought forward above with respect to FIG. 2 shall be valid for FIG. 4 as well with the exception that merely the encoder performs the optimization tasks and the associated decisions with respect to coding options. However, all the description with respect to block-subdivisioning, prediction, dequantization and retransforming is also valid for the decoder 54 of FIG. 4.

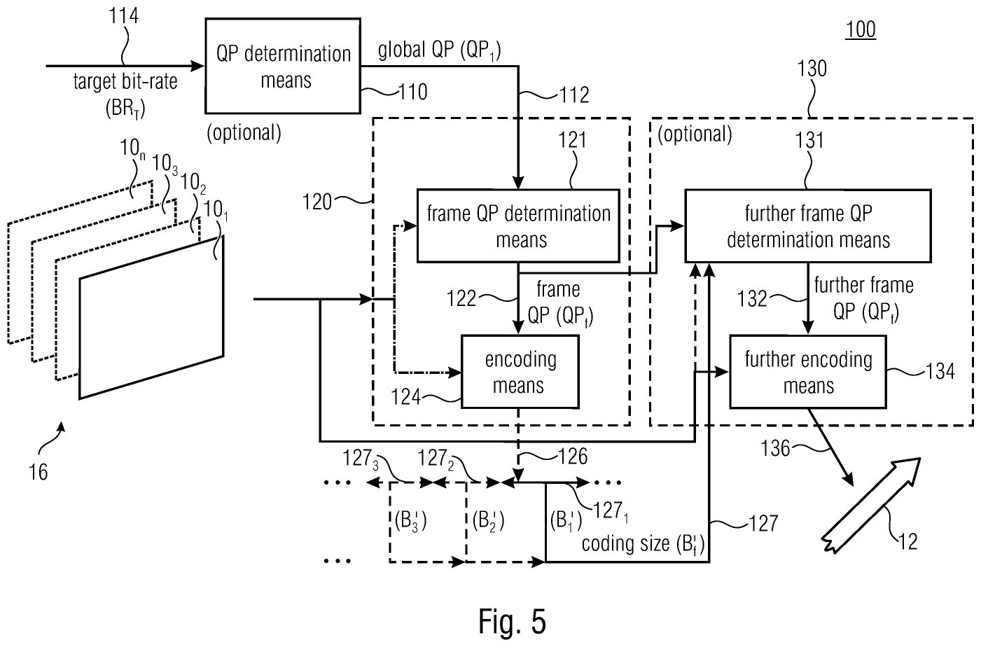

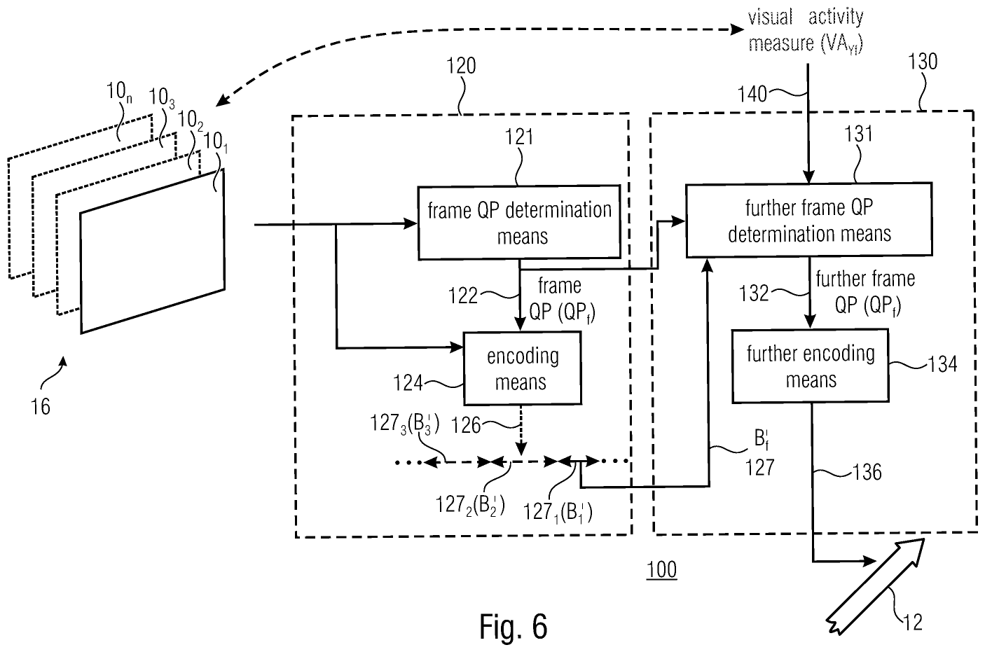

The RC encoding described in the following, see FIGS. 5, 6 and 9, may be implemented in the quantizer 30 and/or the entropy encoder 28b of the encoder 14 shown in FIG. 2 or in the dequantizer 38′ or entropy decoder 56 of the decoder 54 shown in FIG. 4. Optionally, the encoder 14 and/or the decoder 54 may comprise an apparatus for detecting a scene transition, as will be described with regard to FIGS. 5, 6, and/or 9.

The present invention proposes four aspects to improve the performance of existing RC approaches like [3]:
1. Alternative RC model for better estimates of frame-wise or picture-wise OP and lambda values for final encoding (compression) in a video encoder, based on a given target bit-count for said frame,
2. Improvement of the alternative RC model of aspect 1 by use of the XPSNR visual activity measure,
3. Improved detection of scene changes/camera switches in the RC model by use of the XPSNR visual activity measure (which is already available when utilizing the proposed improvement of aspect 2),
4. Improved update of the RC statistical model in temporal vicinity of detected scene/camera changes.

Each of these aspects will be described, using figures where appropriate, in a separate subsection hereafter.

Aspect 1: Alternative OP/Lambda-from-Rate Estimation

Conventional RC systems, including two-pass variants, are often based on a so-called λ-domain paradigm [1], [8], [9] (λ: Lagrange parameter), initially devised for frame or block-level RC applications. With two-pass RC methods, however, it is possible to obtain highly relevant compression statistics already in a first analysis coding pass, usually configured for faster runtime than the second final coding pass (see e.g. [3]) making it possible to reach objectively (in e.g. PSNR) or subjectively (in terms of visual coding quality) better RC results.

FIG. 5 shows an apparatus 100 for encoding a video 16 having a sequence of frames 10₁ to 10ₙ using rate control.

The apparatus 100 may be configured to determine a global quantization parameter 112, e.g., QP₁, for the sequence of frames 10₁ to 10ₙ based on a target bit-rate 114, e.g., BR_{T}. For example, the determination may be performed using a quantization parameter determination means 110, i.e. a OP determinator. The target bit rate 114 may be chosen/provided by a user of the apparatus 100. It is only optional that the global quantization parameter 112 is adapted/determined based on input information. Alternatively, it is also possible that the apparatus 100 uses a preset/predetermined global quantization parameter 112 instead of determining same.

According to an embodiment, the apparatus 100 may consider additionally to the target bit-rate 114 also dimensions, like a width and/or height, of the frames 10 of the sequence of frames 10₁ to 10₄ at the determination of the global quantization parameter 112. The dimensions of the frames 10 may be measured in pixels.

According to an embodiment, the apparatus 100 is configured to perform, for each frame 10 of the sequence of frames 10₁ to 10ₙ, the determining of the frame quantization parameter 122 for each frame of the sequence of frames 10₁ to 10ₙ on the basis of the global quantization parameter 112 depending on a frame coding type and/or a temporal hierarchy level of the respective frame.

The apparatus 100 is configured to perform a coding pass 120, e.g., a first coding pass or an analysis coding pass, coding the sequence of frames 10₁ to 10ₙ, using the global quantization parameter 112. The coding pass 120 is performed by determining a frame quantization parameter 122, e.g., OP′₁, per frame 10 of the sequence of frames 10₁ to 10ₙ on the basis of the global quantization parameter 112, e.g., using a frame quantization parameter determination means 121, i.e. a frame OP determinator. Thus, each frame 10 is associated with a frame quantization parameter 122, with which the respective frame 10 can be quantized by the apparatus 100. The global quantization parameter 112 may represent an average of all frame quantization parameters 122 associated with the sequence of frames 10₁ to 10ₙ. Additionally, the coding pass 120 is performed by subjecting the sequence of frames 10₁ to 10ₙ to a rate/distortion (R/D) optimizing encoding 124, e.g. without rate control, by using, for each frame 10, the frame quantization parameter 122 determined for the respective frame 10 so as to obtain an encoded version 126 of an associated coding size 127, e.g., B′₁, for the respective frame 10. The coding size may indicate a number of bits occupied by the encoded version 126 of the respective frame 10, e.g., after the R/D optimized encoding 124. FIG. 5 shows exemplarily a coding size 1271, e.g., B′₁, for a first frame 10₁, a coding size 127₂, e.g., B′₂, for a second frame 10₂ and a coding size 127₃, e.g., B′₃, for a third frame 10₃. Optionally, the apparatus 100 may be configured to obtain a data stream with the first coding pass 120, wherein the data stream comprises, for each frame 10 of the sequence of frames 10₁ to 10ₙ, the respective encoded version 126 of the respective frame 10. Additionally, or Alternatively to providing the data stream, a further coding pass 130 may follow the coding pass 120. In case the apparatus performs only the coding pass 120, this coding pass 120 may be performed with rate control.

The apparatus 100 may be configured to perform the optional further coding pass 130 by determining, for each frame 10 of the sequence of frames 10₁ to 10ₙ, the further frame quantization parameter 132, e.g., QP_{f}, based on the frame quantization parameter 122 determined for the respective frame 10 in the coding pass 120, and based on the coding size 127 of the respective frame 10 obtained by the coding pass 120. The determination of the further frame quantization parameter may be performed using a further frame quantization parameter determination means 131, i.e. a further frame QP determinator.

The optional further coding pass 130 may be performed with rate control, for example, allocating a particular number of bits, e.g., B_{f}, to each frame 10 and estimating therefrom, for each frame 10, coding parameters, like the further frame quantization parameter 132 and/or a Lagrange parameter, for coding the respective frame 10 in the further coding pass 130. The particular number of bits, e.g., B_{f}, may represent a target coding size of the respective frame. The target coding size may be associated with the target bit rate 114 or the target coding size may be derived from the target bit rate 114. The apparatus may be configured to estimate in the further coding pass 130 the further frame quantization parameter 132 for the respective frame based on the number of bits allocated to the respective frame and, for example, improve or correct this estimate based on the coding size 127 and the frame quantization parameter 122 obtained in the coding pass 120 for the respective frame. The coding size 127 of the respective frame 10 obtained by the coding pass 120 can provide a good estimate on the number of bits needed to encode the respective frame and therefore improve the allocation of the number of bits to the respective frame 10 rendering the rate control more efficient. A relationship between the coding size 127 obtained for the respective frame in the coding pass 120 and a number of bits allocated to the respective frame in the further coding pass 130 may be considered in the determination of the further frame quantization parameter 132 to improve an accuracy of the further frame quantization parameter 132.

The apparatus 100 may allocate, for each frame of the sequence of frames 10₁ to 10ₙ, the target coding size to the respective frame 10, for example, on the basis of the target bit rate 114, e.g., the target bit rate 114 is corrected based on the coding size 127 of the respective frame (obtained at the coding pass). The apparatus 100 might be configured to perform the allocating by determining a total target coding size B_{T} for the sequence of frames 10₁ to 10ₙ based on the target bit rate BR_{T}, e.g., B_{T}-BR_{T}*{number of frames of the sequence of frames}/{Frames per second}), determine a sum B₁ over the coding sizes 127 of all frames of the sequence of frames 10₁ to 10ₙ, e.g., B₁=sum_{f}(B′_{f})), and determine the target coding size B_{f} for the respective frame 10 based on the total target coding size B_{T} for the sequence of frames 10₁ to 10ₙ, the sum B₁ and the coding size B′_{f} 127 of the respective frame 10 obtained at the first pass 120. For example, the target coding size B_{f} is derivable according to B_{f}=B′_{f}* B_{T}/B₁, wherein B′_{f} is the coding size 127 of the respective frame obtained by the coding pass 210, B₁=sum_{f}(B′_{f}) and B_{T}-BR_{T}*{number of frames (e.g., of the sequence of frames or of all frames of the video)}/{Frames per second} with BR_{T} being the target bit rate 114.

According to an embodiment, the target coding size, e.g., B_{f}, allocated to the respective frame corresponds to a number of bits, e.g., a bit-count, allocated to the respective frame, e.g., as a target bit consumption for an encoded version 136 of the respective frame obtainable in the further coding pass 130.

The apparatus 100 may be configured to perform the optional further coding pass 130 by subjecting the sequence of frames 10₁ to 10ₙ to a further R/D optimizing encoding 134 by using, for each frame 10, the further frame quantization parameter 132 determined for the respective frame 10, thereby obtaining a coded data stream 12 having the video 16 encoded thereinto.

According to an embodiment, the further R/D optimizing encoding 134 can be performed with single loop RC which varies block QP, e.g., delta QP, so that each frame is encoded according to the target bit rate 114. The respective frame 10 may be divided into blocks 18 and the apparatus 100 may be configured to determine, for each block 18, a respective block quantization parameter based on the further frame quantization parameter 132. The further frame quantization parameter may indicate a set of block quantization parameters, out of which the respective block quantization parameter for the respective block 18 is selected by the apparatus 100. The further frame quantization parameter 132 may represent a frame global quantization parameter. The further frame quantization parameter 132 may represent an average of the set of block quantization parameters. The data stream 12 may comprise the further frame quantization parameter 132 and may indicated for each block 18 the respective block quantization parameter relative to the further frame quantization parameter 132, e.g., as a delta quantization parameter.

According to an alternative embodiment, the further R/D optimizing encoding 134 can be performed by performing a log rate variation along the sequentially coded frames so as to adapt the target bitrate, i.e. a target frame coding size. This might be performed dependent on the obtained coding sizes of the already encoded frames in the further R/D optimizing encoding 134 so that the target bit rate 114 is achieved for the sequence of frames 10₁ to 10ₙ.

According to an embodiment, the apparatus 100 may determine, for each frame, the respective further frame quantization parameter 132 dependent on a visual activity measure 140 associated with the respective frame 10, as will be described in more detail with regard to FIG. 6.

Summary of Inventive Aspect 1

An alternative to the A-domain and, possibly, other published RC statistical models, exhibiting lower model complexity and/or higher objective or subjective performance, can be described in 2 paragraphs as follows.

First, contrary to known technology such as, e.g., [3], where coding of a video sequence in the first RC pass of a multi-pass RC scheme is performed with a fixed predetermined global quantization parameter (QP), it is proposed to utilize a video input adaptive first-pass global QP₁ 112 whose value is determined based on the user specified target bit-rate BR_{T} 114 (e.g. in bits per second) and/or video dimensions, e.g., W·H (product of video width and height). The advantage of this approach, besides maintaining a very low functional complexity, is a slight speedup in the overall runtime of said multi-pass RC scheme, measured as the sum of the runtimes of all RC passes.

Second, having made use of an improved signal adaptive determination of the first-pass QP₁ value, i.e. the global quantization parameter 112, it is also possible to improve the estimation of “slice” QP_{f}, i.e. the further frame quantization parameter 132, and/or λ_{f} values, e.g., further frame Lagrange parameter, used for coding of a specific frame f 10 in the second RC pass, i.e. the further coding pass 130, from an associated bit-count. Generally speaking, the RC method determines and allocates a particular number of bits, or bit-count B_{f}, to each frame to be compressed in the final RC pass (i.e., actual coding run 120 in single-pass RC or second coding run 130 in two-pass RC) and then estimates QP_{f} and λ_{f} from B_{f} such that, ideally, the bit consumption resulting from coding the frame 10 with these parameters matches B_{f}, i.e. the target number of bits, i.e. the coding size, for the respective frame. Instead of employing only indirect statistics as in the known technology to improve the accuracy of such “QP_{f}, λ_{f} from B_{f}” estimates, improving only relatively slowly over time (i.e. as more frames are encoded), it is proposed to make direct use of the 1st-pass frame-wise QP′_{f}, 122, λ′_{f}, and/or associated resulting B′_{f} values, coding size 127, (which depend solely on QP₁ 112 and some other constant encoder configuration parameters) to estimate QP_{f} 132 and/or λ_{f} In other words, it is proposed to determine, for a given frame f 10, QP_{f}, 132 and/or λ_{f} not only from QP, λ results collected while coding previous frames 10 of the video sequence 16 in the same RC pass, e.g., in the further coding pass 130 in FIG. 5 (e.g., the final pass. with frame index fₚ<f, as in the known technology of, e.g., [1], [8], [9]), but also from one or more QP′_{f}/λ′_{f}/B′_{f} value triples collected in a different RC pass (e.g., in the coding pass 120, e.g., the previously occurring analysis pass in two-pass RC). The λ_{f} value is then derived from the QP_{f} value 132. This “two-dimensional” temporal RC method was found to improve the RC accuracy and, thereby, stability.

### Advantageous Embodiment for Aspect 1

The improved input/BR_{T} adaptive derivation of the first-pass “average” QP₁, i.e. the global quantization parameter 112, is advantageously realized as follows, i.e. with a determination function:

QP₁=max(QPₘᵢₙ,QPₘₐₓ−round(\sqrt{d·BR_{T}/1000000}), (1)

where BRᵣ, i.e. the target bit rate 114, is the user specified target number of bits per second (thus converted to Mbit/s in the equation), QPₘᵢₙ=17 or 7 and QPₘₐₓ=40 are developer specified constants (lower and upper OP limits which may vary with the compression technology, e.g., QPₘᵢₙ, may indicate a minimum quantization parameter and QPₘₐₓ may indicated a maximum quantization parameter), and d=(3840·2160)/(W·H) is the video input dimension dependency of the inventive method. Note that all numerical values above were chosen for WC [2] and their choice may vary.

In equation (1) above, the term d/1000000 may be regarded as a constant, e.g., z, since the width and height of the frames 10 of the sequence of frames 10₁ to 10ₙ does normally not change within the sequence. But the constant may have a different value for a different sequence of frames with frames of another dimension. In other words, the constant z may represent a ratio of a dimension parameter d, which is dependent on the width and the height of the frames of the sequence of frames, divided by 1000000.

The alternative “QP_{f}, λ_{f} from B_{f}” estimate is, advantageously, realized, e.g., with a further determination function, using the associated different-pass data as

QP_{f}=Clip3(QPₘᵢₙ,QPₘₐₓ,round(QP′_{f}−a·log₂(B_{f}/B′_{f}))) (2)

or

QP_{f}=Clip3(QPₘᵢₙ,QPₘₐₓ,round(QP′_{f}+a·log₂(B′_{f}/B_{f}))), (3)

where limits QPₘᵢₙ and QPₘₐₓ may, but don't need to, be chosen as above, and Clip3 ( . . . ) enforces the range QPₘᵢₙ≤QP_{f}≤QPₘₐₓ on the “slice” QP value 132 used for final coding of the given frame f 10. It was found that, for random-access coding, a=0.1367. QP′_{f}, is a good choice which, however, is coding technology dependent. The further determination function, i.e., equation (2) or (3), depends on a deviation, e.g., a ratio, between the target coding size, e.g. B_{f}, of the respective frame and the coding size 127, e.g., B′_{f},

The term B_{f}/B′_{f} may represent a deviation, e.g., a ratio, between a target coding size B_{f} of the respective frame 10 and the coding size B′_{f} 127 of the respective frame 10 obtained by the coding pass 120. The further frame quantization parameter 132 for the respective frame 10 may be determined dependent on the respective deviation such that the respective further frame quantization parameter 132 is associated with a coarser quantization than the respective frame quantization parameter 122 in case of the respective coding size 127 being larger than the respective target coding size B_{f} and the respective further frame quantization parameter 132 is associated with a finer quantization than the respective frame quantization parameter 122 in case of the respective coding size 127 being smaller than the target coding size B_{f}.

According to an embodiment, the apparatus 100 may be configured to adapt the further determination function, e.g., during the further coding pass 130, according to a previously encoded frame or according to previously encoded frames, e.g., such as via c_{f} adaptation, as will be described in more detail under aspect two in the following. The c_{f} adaptation may be performed depending on a ratio between an even further coding size, e.g., B″_{f}, resulting from the further RD optimizing encoding 134 of the respective frame on the one hand and the target coding size, e.g., B_{f}, or the coding size 127, e.g., B′_{f}, of the respective frame on the other hand.

According to an embodiment, the apparatus 100 may be configured to determine during the coding pass 120 additionally a frame Lagrange parameter A′_{f} for each frame of the sequence of frames 10₁ to 10ₙ on the basis of the global quantization parameter 112 or on the basis of the respective frame quantization parameter 122 determined for the respective frame. The apparatus 100 may be configured to perform the R/D optimizing encoding 124 of the respective frame 10 further using the respective frame Lagrange parameter λ′_{f} determined for the respective frame.

According to an embodiment, the apparatus 100 may be configured to determine during the further coding pass 130 a further frame Lagrange parameter λ_{f} for each frame of the sequence of frames 10₁ to 10ₙ based on the respective further frame quantization parameter 132 determined for the respective frame 10, and to perform the further R/D optimizing encoding 134 of the respective frame 10 further using the respective further frame Lagrange parameter λ_{f} determined for the respective frame 10. Optionally, the apparatus 100 may additionally to the respective further frame quantization parameter 132 also consider the respective frame quantization parameter 122 and the respective Lagrange parameter λ′_{f} determined for the respective frame 10 at the determination of the respective further frame Lagrange parameter λ_{f}.

The further frame Lagrange parameter λ_{f} can be obtained from same-pass QP_{f} 132 and different-pass QP′_{f} 122 and λ′_{f} as follows, e.g., see [12]:

λ_{f}=λ′_{f}·2(QP_{f}−QP′_{If})/3. (4)

Note that the above advantageous embodiment may be combined with prior-art temporal RC model updates or improvements using the coding results of previous same-pass frames as already indicated earlier [1], [8], [9]. Furthermore, the base-2 logarithm log₂ in (2) and/or (3) may easily be replaceable by a logarithm with a different base (e.g., 10) as long as the numerical constant in a (here 0.1367) is adapted accordingly (e.g., 0.454 with log₁₀).

Aspect 2: Perceptually Motivated Improvement of Alternative Estimation

The “QP, λ from target bit-count” estimator, e.g., the apparatus 100 shown in FIG. 5, proposed in the previous section works accurately overall, i.e., on average across a set of typical video material 16. On certain boundary-case video sequences 16 with unusual content statistics (e.g., high level of camera noise or film grain, strong fine or coarse texture, highly irregular motion, or chromatic aberration), said estimator may, however, yield inaccurate predictions of the QP_{f}, i.e. the further frame quantization parameter 132, and λ_{f} parameters used for coding a particular frame 10 and, thereby, cause the bit consumption after final coding, e.g., performed by the further coding pass 130, of a frame t 10 to deviate significantly from the target bit-count B_{f} allocated by the RC to that particular frame 10.

The apparatus 100 shown in FIG. 6 may comprise the same features and or functionalities as described for the apparatus 100 in FIG. 5, but is additionally configured to perform the further coding pass 130 by determining, for each frame 10 of the sequence of frames 10₁ to 10ₙ, dependent on a visual activity measure 140 of the respective frame 10, the further frame quantization parameter 132. The respective visual activity measure 140 is indicative of a content statistic of the respective frame 10 and can therefore enable the apparatus 100 to work accurately over all types of video materials 16. The visual activity measure, e.g., VA_{Y}_{_{f}}, corresponds to a measure of dispersion (e.g., a standard deviation, a mean absolute difference, a median absolute deviation, an average absolute deviation or a distance standard deviation) of a statistical sample value distribution of a high-pass filtered, e.g., in spatial and temporal direction, version of the respective frame, and/or a high-pass filtered, e.g., in spatial and temporal direction, version of the respective frame. The determination of the further frame quantization parameter 132 is still based on the frame quantization parameter 122 determined for the respective frame 10, and the coding size 127 of the respective frame 10 obtained by the coding pass 120, as described with regard to FIG. 5.

According to an embodiment, the apparatus 100 may be configured to determine, for each frame 10 of the sequence of frames 10₁ to 10ₙ, the respective visual activity measure 140, e.g., using visual activity measure determination means or visual activity measure determinator.

Furthermore, the apparatus 100 is configured to perform the further coding pass 130 by subjecting the sequence of frames 10₁ to 10ₙ to a further R/D optimizing encoding 134 by using, for each frame 10, the further frame quantization parameter 132 determined for the respective frame 10, thereby obtaining a coded data stream 12 having the video 16 encoded thereinto.

FIG. 6 shows exemplarily an apparatus 100, which is configured to perform the coding pass 120 slightly different compared to the coding pass 120 shown in FIG. 5, but it is clear, that the apparatus 100, can alternatively perform the coding pass 120 identical to the apparatus 100 described in FIG. 5.

The apparatus 100 shown in FIG. 6 is configured to perform the coding pass 120 by determining a frame quantization parameter 122 per frame 10 of the sequence of frames 10₁ to 10ₙ, and by subjecting the sequence of frames 10₁ to 10ₙ to a rate/distortion (R/D) optimizing encoding 124 by using, for each frame 10, the frame quantization parameter 122 determined for the respective frame 10 so as to obtain an encoded version 126 of an associated coding size 127 for the respective frame 10.

According to an embodiment, the further coding pass 130 is performed with RC. The apparatus 100 may be configured to allocate, for each frame 10 of the sequence of frames 10₁ to 10ₙ, a target coding size, e.g. a number of bits B_{f} or a bit count, to the respective frame, and perform, for each frame 10 of the sequence of frames 10₁ 10ₙ, the determining of the further frame quantization parameter 132, e.g., QP_{f}, further based on the target coding size of the respective frame 10. The target coding size, e.g., is associated with a target bit rate 114 for the sequence of frames 10₁ to 10ₙ. For example, the target coding size may represent a target bit consumption for an encoded version 136 of the respective frame 10 obtainable in the further coding pass 130.

According to an embodiment, the apparatus 100 is configured to correct, for each frame 10 of the sequence of frames 10₁ to 10ₙ, the respective further frame quantization parameter 132 dependent on the visual activity measure 140 of the respective frame 10. The visual activity measure 140 may indicate how much the further frame quantization parameter 132 has to be corrected. For example, the higher the visual activity measure 140 is, the lower is a correction amount. The visual activity measure 140 may be configured to correct an underestimation or an overestimation of a bit-consumption of the respective frame. This may be entailed, if the apparatus allocates a target coding size to the respective frame, which target coding size will not be reached at the further R/D optimizing encoding of the respective frame. The further frame quantization parameter 132, for example, is modified by a correction amount to result into a coarser quantization parameter in case of a further coding size of the respective frame being larger than the target coding size, and to result into a finer quantization in case of the further coding size of the respective frame being lower than the target coding size. The further coding size of the respective frame 10 may indicate a number of bits occupied by the encoded version 136 of the respective frame 10, e.g., after the further R/D optimized encoding 134. The further frame quantization parameter 132, for example, is modified with the parameter a′ described in equations (6) and (7) in the following. The above described correction may result in corrected versions of the further frame quantization parameter 132. The further frame quantization parameter determination means 131 may be configured to provide the corrected version of the further frame quantization parameter 132 as the further frame quantization parameter 132.

Summary of Inventive Aspect 2

In the following, an extension to the above QP/λ estimator, e.g., the apparatus 100 shown in FIG. 5, utilizing the XPSNR visual model [7], is described. However, it is clear that the features and/or functionalities described in the following may also be applicable to the apparatus 100 shown in FIG. 6. This extension makes use of a perceptually motivated visual activity measure 140 to improve the model accuracy. Said visual activity measure 140 may be regarded as a measure of dispersion of a statistical sample value distribution of a high-pass filtered (in spatial and temporal direction) version of each input frame/picture [10], [11].

A possible corner-case inaccuracy of the “QP, λ from target rate” estimator 100 may manifest itself in two forms:
Underestimation of resulting bit-consumption: the frame's QP_{f} 132, λ_{f} obtained via equations (2) to (4) may be too low, resulting in a notably higher bit-count after final coding 134 of frame f 10 than intended by the RC. The solution here must be to assign a QP_{f} value 132 to f 10 which is higher than the value returned by equation (2) or (3).
Overestimation of the resulting bit-consumption: the frame's QP_{f} 132, λ_{f} values of equations (2) to (4) may be too high, causing the bit-count after final coding 134 of frame f 10 to be lower than the consumption intended by the RC. Here, the solution must be to derive a QP_{f} value 132 which is lower than that derived by equation (2) or (3).

It was found empirically that the luma-component visual activity measure 140, determined in the low-complexity XPSNR model of the human visual system (details of which are published in [7] and [10]-[12]) and given by

$$V {A}_{{Y}_{f}} = max ( {a}_{min}^{2} , {( \frac{1}{4 W \cdot H} {\sum }_{[ x , y ] ∈ {P}_{f}} \vert {h}_{{s}_{f}} [ x , y ] \vert + 2 \vert {h}_{{t}_{f}} [ x , y ] \vert )}^{2} ) , \qquad ( 5 )$$

$${h}_{{t}_{f}} [ x , y ] = {s}_{f} [ x , y ] - {s}_{f - 1} [ x , y ] ,$$

with s_{f}=frame samples, P_{f}=luma-component input picture of frame f 10, and all other parameters as given in [7], [11], serves as a good indicator of the possibility and particular form of said corner-case inaccuracy. The variable s_{f} may represent a motion picture signal and may be associated with the input P_{f}. The character aₘᵢₙ is a minimal visual activity measure, W is a width, e.g., in pixel, of the respective frame f, H is a height, e.g., in pixel, of the respective frame f, [x, y] are horizontal and vertical sample coordinates. Note that the spatial high-pass filtering towards the calculation of the visual activity value VA_{Y} 140 is indicated by the hₛ signal while the temporal high-pass filtering part of the visual activity 140 is indicated by the h_{f} signal.

With VA_{Y} 140, it is possible to improve the prediction accuracy of eq. (2) or (3) simply by augmenting the definition of its parameter a to include a dependency on equation (5). In other words, it is proposed to make equations (2) or (3) depend on VA_{Y} 140.

### Advantageous Embodiment for Aspect 2

Extending equation (2) and/or (3) by a dependency on VA_{Y} 140 is, advantageously, done as follows, with constant μ_{VA}=mean VA_{Y} value:

QP_{f}=Clip3(QPₘᵢₙ,QPₘₐₓ,round(QP′_{f}−a′·log₂(B_{f}/B′_{f})))with a′=(0.1367±(VA_{Y}_{_{f}}−μ_{VA})/16384)·QP′_{f}·c_{f} (6)

or

QP_{f}=Clip3(QPₘᵢₙ,QPₘₐₓround(QP′_{f}−a′·log₂(B_{f}/B_{f}))),with a′=(0.1367±(μ_{VA}−VA_{Y}_{_{f}})/16384)·QP′_{f}·c_{f} (7)

In other words, parameter a in equation (2) and/or (2) is replaced by a visual activity 140 dependent a′, calculated as the sum of, or difference between, a of (2) or (3), e.g. with value 0.1367·QP′_{f} as above, and some further parameter dependent on VA_{Y}_{_{f}}r 140. Thus, the apparatus 100 may be configured to determine the further frame quantization parameter 132 dependent on a mean visual activity measure, e.g., μ_{VA}, e.g., a temporal mean visual activity measure; e.g., determined across two or more frames; or e.g., a constant mean visual activity measure independent of the content of the video; e.g. the mean visual activity measure is determined for typical video material. Furthermore, the base-2 logarithm log₂ in (6) and (7) may easily be replaceable by a logarithm with a different base (e.g., 10) as long as the numerical constant in a (here 0.1367) is adapted accordingly (e.g., 0.454 with log₁₀).

Note that a correction factor c can be included as well. This factor is initially equal to 1 but may be adapted (except during a scene/camera switch, where it may be updated to 1, see below), e.g. as follows:

C_{f+frameDistance(tempLevel)=Clip}3(1/4,4, c_{f}·(B_{f}/B″_{f})^{b}),b<1and,advantageously,b=1/6,B′_{f}, bits

after 2^{nd} pass. Adaptation of c is advantageously done separately for each temporal layer 210 tempLevel (one c per tempLevel).

The apparatus 100 may be configured to perform, for each frame 10 of the sequence of frames 10₁ to 10ₙ, the determining of the further frame quantization parameter 132 according to the further determination function, i.e. equation 6 or 7, of the deviation between the target coding size B_{f} of the respective frame and the coding size 127, i.e. B′_{f}, and to adapt the further determination function for the respective frame according to a previously encoded frame, e.g., using the correction factor c. The previously encoded frame may correspond to the same temporal hierarchy level as the respective frame, i.e. the frame currently to be encoded.

As can be seen in the equation above, the correction factor c may depend on a deviation between an even further coding size, i.e. B″_{f}, resulting from the further RD optimizing encoding 134 for the previously encoded frame on the one hand and the target coding size B_{f} or the coding size 127, i.e. B′_{f}, of the previously encoded frame on the other hand. Therefore, the apparatus 100 may be configured to adapt the further determination function for the respective frame dependent on this deviation.

Explanation of c_{f}

Aspect 2 may include the definition of a frame-wise correction factor c_{f}, which is used to adjust the parameter a, or a′, over time based on previously coded frames. For best adjustment performance, these previously coded frames are restricted to belong to
the same scene (grouping of frames with similar characteristics, i.e. input dependency)
the same temporal hierarchical level 210 (or layer, i.e. encoding configuration dependency).

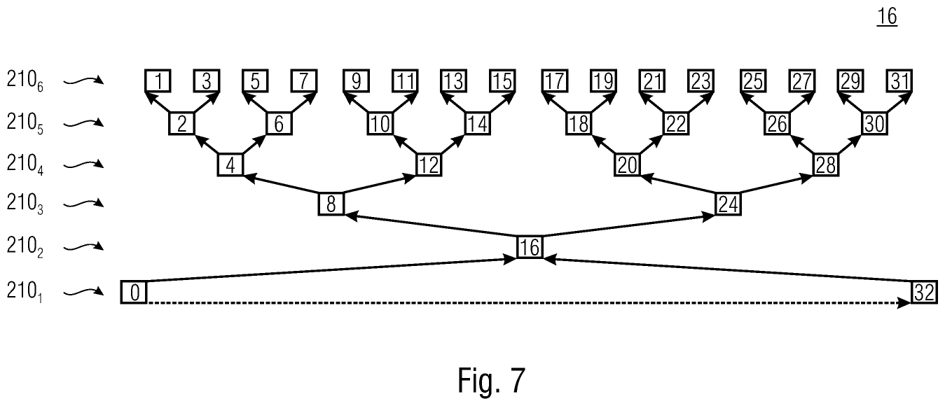

FIG. 7 shows an example of such a temporally hierarchical encoding configuration, here a group of picture (GOP) of size 32. The different temporal layers, or levels, in this example are indicated horizontally by labels 210₁ through 210₆. The values in the blocks indicate the indices of the individual pictures (0-32), i.e., the temporal positions of said pictures in display order. The group of picture (GOP) of size 32 shown in FIG. 7 may represent a sequence of frames, as mentioned with regard to FIGS. 5, 6 and 9. Note that the dyadic segmentation into the different temporal levels 210 means that the temporal distance between successive pictures, e.g., frames, within a given temporal level 210 depends on the level and decreases with increasing level. For example, at the lowest level 210₁, the distance between two successive frames belonging to that lowest level equals the GOP size itself, i.e., 32 here, while at the highest level 210₆, the distance between two successive frames of that highest level reaches a minimum value, i.e., 2 here. Note, furthermore, that all distances resulting from the example in FIG. 7 amount to a power of two, i.e. 32, 16, 8, 4, or 2. In other words, the temporal distance, in display order and units of frames, between two frames belonging to some temporal hierarchy layer 210 tempLevel can be defined by frameDistance(tempLevel), i.e. a function returning said temporal distance in dependence on tempLevel. With this function and index f of the currently processed frame, it is possible to identify the index fₙₑₓₜ of the next processed frame associated with the same temporal level 210 as frame f, which is convenient since it allows us to achieve the abovementioned restriction to the same temporal hierarchy level 210 in the adjustment using, for example, the abovementioned correction factor c_{f}:

C_{f+frameDistance(tempLevel)}=Clip3(1/4,4,c_{f}·(B_{f}/B″_{f})^{b})with 0<b<1.

In other words, given a frame f associated with tempLevel (i.e., belonging to the temporal hierarchy layer 210 defined by tempLevel), a previously defined correction factor c_{f} associated with f, and data obtained by analysis and/or encoding (here, using c) of the motion picture associated with f (here, B_{f} and B″_{f} as defined before), the above equation allows to derive the correction factor to be used during encoding of the next frame associated with tempLevel. To conclude, if we further enforce that correction factor c is reset, e.g. to a value of 1, before encoding the first frame, associated with tempLevel, at or after a scene change/camera switch, said equation specifies a “same temporal level” and “same scene” constrained correction factor, as desired.

Aspect 3: Improved Detection of Scene Changes or Camera Switches

A typical video sequence 16 (e.g. a movie) contains relatively frequent scene changes or camera switches, i.e. scene transitions 152, after which the local characteristics of the sequence usually change. Differences in the content throughout the video sequence 16 can affect the encoding performance, especially if RC is being used. Hence, it is crucial for a practical video encoder to correctly detect 150 the local changes of video content characteristics and take the appropriate measures to control the coding quality and bitrate. A robust such detector is outlined hereafter.

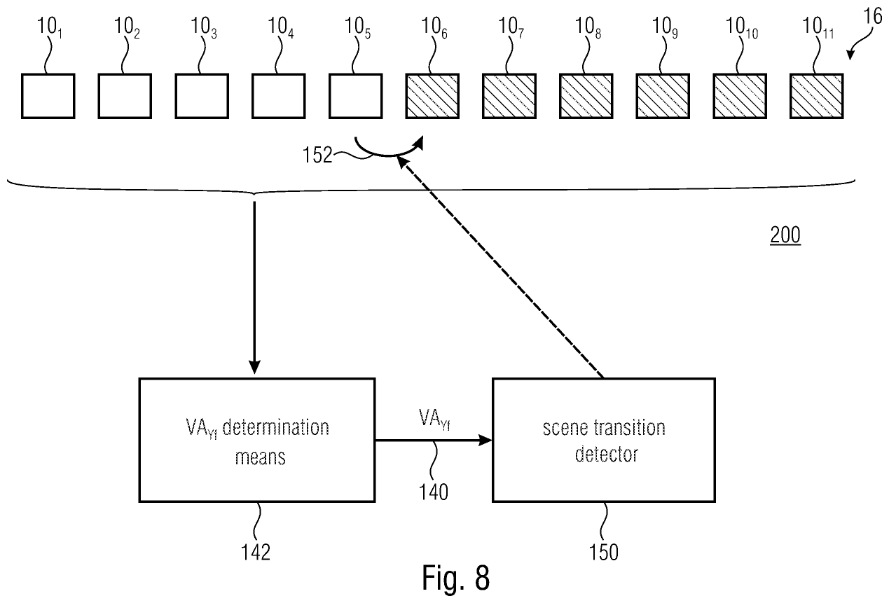

FIG. 8 shows an embodiment of an apparatus 200 for detecting a scene transition 152, e.g., a scene change and/or a camera switch, in a sequence of frames 10₁ to 10₁₁. The apparatus 200 is configured to determine, for each frame 10 of the sequence of frames 10₁ to 10₁₁ a visual activity measure 140, e.g., VA_{Y}_{_{f}}, and detect the scene transition 152 based on the visual activity measure 140. The visual activity measure 140 may be determined by the apparatus 200 using a visual activity measure determination means or a visual activity measure determinator. The apparatus 200 may be configured to detect the scene transition 152 using a scene transition detector or a visual activity measure evaluator. At the detection of the scene transition 152 the apparatus may be configured to evaluate the visual activity measures, which have been obtained for all frames 10 of the sequence of frames 10₁ to 10₁₁. The visual activity measure 140 may be defined as described above in aspect 2. The visual activity measure 140 may correspond to the visual activity measure 140 described with regard to aspect 2.

According to an embodiment, the apparatus 200 is configured to detect the scene transition 152 at a current frame, e.g., f, based on the visual activity measure 140, e.g., VA_{Y}_{_{f}}, associated with the current frame, e.g., f, and on the visual activity measure 140, e.g., VA_{Y}_{_{f−1}}, associated with a preceding frame, e.g., f−1, e.g., in display order. FIG. 8 shows the frames 10 of the sequence of frames 10₁ to 10₁₁ in display order and not in encoding order. FIG. 8 shows exemplarily a scene transition between frames 10₅ and 10₆.

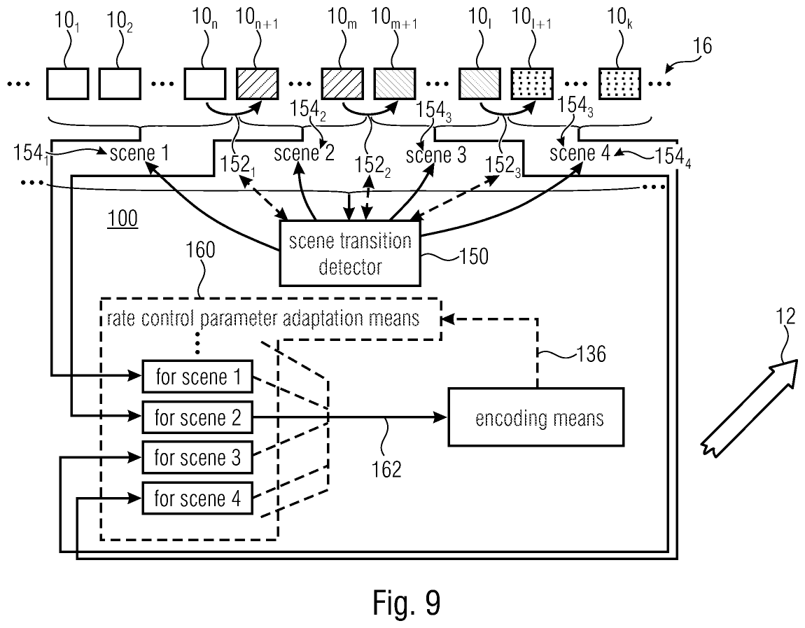

According to an embodiment, one of the herein described apparatuses 100, see FIG. 5, FIG. 6 and FIG. 9 may comprise the apparatus 200 shown in FIG. 8.

Summary of Inventive Aspect 3

When an abrupt scene change or camera switch, i.e. a scene transition 152, occurs in a video sequence, the values of the visual activity 140 described earlier for two consecutive frames 10₅ and 10₆ (in display order) would typically have notably different values. Let us consider an example where an abrupt scene change 152 happens at frame f, e.g., 10₆. As indicated by hₜ in equation (5), to calculate the visual activity 140 of frame f, e.g., 10₆, frame f−1, e.g., 10₅, from a different scene is used. However, when calculating the visual activity 140 of frame f−1, e.g., 10₅, frame f−2, e.g., 10₄, is used, which belongs to the same scene as frame f−1, e.g., 10₅. For these reasons, it is expected that VA_{Y}_{_{f}} 140 and VA_{Y}_{_{f−1}} 140 will exhibit significantly different values. To quantify that difference, a ratio r_{VA} between the visual activity values 140 of the current and previous frame is calculated as:

$${r}_{V A} = \frac{V {A}_{{Y}_{f}}}{V {A}_{{Y}_{f - 1}}} . \qquad ( 8 )$$

The ratio r_{VA} may represent a quotient of a division between a dividend derived by the visual activity measure 140, e.g., VA_{Y}_{_{f}}, associated with the current frame, e.g., f, and a divisor derived by the visual activity measure 140, e.g., VA_{Y}_{_{f−1}}, associated with a preceding frame, e.g., f−1.

It should be noted that, by definition, VA_{Y}_{_{f−1}}, 140 can never take a value of 0; aₘᵢₙ²>0 in (5) [7]. As previously discussed, a high value of r_{VA} can be a good indication of a scene change or camera switch, i.e. a scene transition 152. Hence, in the proposed scene change or camera switch detection algorithm, a new scene is detected whenever r_{VA}> t, where t is a predefined threshold greater than 1. Note that, in implementations, \sqrt{r_{VA}}>\sqrt{t} may be utilized.

### Advantageous Embodiment for Aspect 3

In the advantageous realization, a new scene is detected whenever the following relation is evaluated and found to be true, where the evaluation is performed before final encoding of frame f (and writeout to a bitstream):

VA_{Y}_{_{f}}=t·VA_{Y}_{_{f−1}} (9)
where the advantageous value of threshold t is 7.5. In other words the apparatus 200 may be configured to detect a scene transition 152 in case of the visual activity measure 140, e.g., VA_{Y}_{_{f}}, associated with the current frame, e.g., f exceeds the visual activity measure 140, e.g., VA_{Y}_{_{f−1}}, associated with a preceding frame, e.g., f−1, multiplied with a predetermined value, e.g., t. However, it should be noted that for a specific use case and depending on the video sequence characteristics or coding technology, different values of t may be optimal.

Furthermore, potential detection of false positives may be suppressed by introducing a minimum duration m>1 (in units of frames) of each scene, i.e. a minimum distance between two detected scene or camera changes, i.e., between two scene transitions 152. This value can be fixed (e.g. m=8) or it can depend on the sequence's frame rate (e.g. m=round (fps/4), where fps indicates the number of frames per second). More specifically, when a scene is detected at frame f and, subsequently, evaluation of (6) would cause a new scene to be detected at frame f+i, with 0<i<m, detection of the latter may be suppressed and subsequent scenes may only start at frames i≥m. In other words, a scene is associated with a predetermined duration, and the apparatus 200 may be configured to suppress a detection of a scene transition 152 at a current frame, if the current frame occurs during the predetermined duration. The predetermined number may represent a minimum number, e.g., m, of frames.

Aspect 4: Improved Update of RC Statistical Model after Scene Changes/Camera Switches

In many RC methods, statistical models are used to formulate the relationship between the encoding parameters, e.g., rate control parameters 162, and the actual bitrate [1], [8], [9]. These statistical models are typically updated during the encoding to better adapt to the local characteristics of the encoded sequence 16. However, with the presence of scene changes or camera switches, i.e. scene transitions 152, in the sequence 16, the statistical models which were used in previous scenes 154 may no longer be valid for the new scene 154. Hence, to improve the overall encoding performance, the RC statistical models and their corresponding parameters, e.g., rate control parameters 162, should be updated when the new scene 154 is detected.

FIG. 9 shows an apparatus 100 for encoding a video 16 using rate control. The features and/or functionalities described with regard to the apparatus 100 in FIG. 9 may be implemented in the apparatus 100 in FIG. 5 or in the apparatus 100 in FIG. 6.

The apparatus 100 is configured to detect scene transitions 152, e.g, 152₁ to 152₃, between a number of scenes 154, e.g., 154₁ to 154₄, in a sequence 16 of frames, so that each frame 10 of the sequence 16 of frames is associated with a scene 154 of the number of scenes 154.

For this detection the apparatus 100 might comprise the apparatus 200 of FIG. 8 or a scene transition detector 150. In FIG. 9 the apparatus 100 exemplarily detects a scene transition 152₁ between frames 10ₙ and 10ₙ₊₁, a scene transition 152₂ between frames 10ₘ and 10ₘ₊₁ and a scene transition 152₃ between frames 10ₗ and 10ₗ₊₁. Based on the detected scene transitions 152 the apparatus 100 is configured to associate frames 10₁ to 10ₙ with a first scene 154₁, frames 10ₙ₊₁ to 10ₘ with a second scene 154₂, frames 10ₘ₊₁ to 10ₗ with a third scene 154₃ and frames 10ₗ₊₁ to 10ₖ with a fourth scene 154₄. FIG. 9, for example, shows the sequence 16 of frames in display order.

Additionally, the apparatus 100 is configured to encode the sequence 16 of frames using rate control by adapting, separately for each scene 154, a rate control parameter 162, e.g., QP_{f}, a, a′, λ, α or β, for a frame 10 of the respective scene 154 depending on a characteristic of an encoded version 136 of frames which precede the frame in coding order and are associated with the respective scene 154. The characteristic of an encoded version of a frame might represent encoding parameters, like rate control parameters, used for obtaining the encoded version or a visual activity measure determined for the respective frame or output statistics of the encoded version of the frame, like a coding size or its deviation from a target size, e.g., from an allocated number of bits. The adaptation of the rate control parameter may be performed using a rate control parameter adaptation means 160.

Additionally, the apparatus 100 is configured to encode the sequence 16 of frames using rate control by setting, for each scene 154, the rate control parameter 162 to a predetermined setting for a firstly encountered frame of the respective scene 154, e.g., firstly encountered in encoding order. The predetermined setting might be a default setting, or might be an estimated setting estimated based on one or more frames associated with the respective scene such as based on an analysis of the visual activity measure 140 of these frames (frames of the same scene, e.g., following the respective frame in encoding order). The predetermined setting might be determined depending on a frame coding type and/or a temporal hierarchy level 210, e.g., a temporal layer, of the respective frame. The apparatus 100 may be configured to derive the predetermined setting by evaluating one or more frames of the respective scene 154, which one or more frames are already available but not yet encoded, so as to obtain an evaluation result, and by deriving the predetermined setting based on the evaluation result.

According to an embodiment, the apparatus 100 may be configured to perform a coding pass 120 and a further coding pass 130, e.g., as described with regard to FIG. 5 or 6. For example, the apparatus 100 may be configured to perform the coding pass by determining a frame encoding parameter, e.g., the frame quantization parameter 122, per frame of the sequence 16 of frames, and by subjecting the sequence 16 of frames to R/D optimizing encoding 124 by using, for each frame 10, the frame encoding parameter 122 determined for the respective frame so as to obtain an encoded version 126 of an associated coding size 127 for the respective frame. The apparatus 100 may be configured to perform the further coding pass 130 by determining, for each frame 10 of the sequence 16 of frames, using a determination function, e.g., equation (2) or (3) or (6) or (7), a further frame encoding parameter, e.g., the further frame quantization parameter 132, based on the frame encoding parameter 122 determined for the respective frame, and based on the coding size 127 of the respective frame obtained by the coding pass 120. Additionally, the further coding pass 130 is performed by subjecting the sequence 16 of frames to a further R/D optimizing encoding 134 by using, for each frame 10, the further frame encoding parameter 132 determined for the respective frame, thereby obtaining a coded data stream 12 having the video encoded thereinto. In this case, the rate control parameter 162 may correspond to the further frame encoding parameter 132, e.g., QP_{f}, and the apparatus 100 may be configured to adapt the rate control parameter 162/132 by adapting the determination function, depending on the characteristic of the encoded version of frames which precede the frame in coding order and are associated with the respective scene, e.g., as described with regard to the correction factor c under aspect two. The determination function is above described as a further determination function. For example, if the frame QP is determined in the coding pass 120 with a determination function dependent on the global quantization parameter, than the function, i.e. equations (2), (3), (6) and (7), for determining the further frame quantization parameter 132 is regarded as a further determination function. Otherwise the further determination function might also be named determination function.

According to an embodiment, the further frame encoding parameter 132 may be determined based on a visual activity measure 140, e.g., as described for the further frame quantization parameter 132 in FIG. 6.

Summary of the Inventive Aspect 4

Many RC algorithms use the RC statistical models to select the encoding parameters, such as QP 122, 132 or Lagrange parameter λ, to meet the target rate 114. One of the most commonly used models in RC methods for HEVC and VVC is the R−λ model [5], [8]. In this model, λ is calculated from the target rate 114 (bits per pixel, bpp) using a hyperbolic model:

λ=α·bpp^{β}, (10)
where α and β are model parameters, e.g., rate control parameters 162. In case of hierarchical encoding structures, it is a common practice to use different model parameters α and β 162 for frames of different temporal levels 210 (or layers). It was shown that estimating model parameters at the beginning of a sequence, instead of using the default values, can improve the performance of the RC [1]. Hence, instead of using the suboptimal approach where a statistical model from the previous scene 154 is used for the new scene 154 and then gradually updated, better encoding performance may be achieved when the RC statistical model and its corresponding parameters, e.g., the rate control parameters 162, are updated when the scene change or camera switch, i.e. the scene transition 152, is detected. To be able to update the RC statistical model parameters 162 at the beginning of the new scene 154, (pre-)analysis or (pre-)encoding may, advantageously, be performed for frames that belong to the new scene. Once the parameters 162 of the RC statistical model for the new scene 154 are estimated, the RC replaces the statistical model parameters with the updated values and uses them for the upcoming frames. This process is repeated whenever a new scene change or camera switch 152 is detected.

### Advantageous Embodiment for Aspect 4

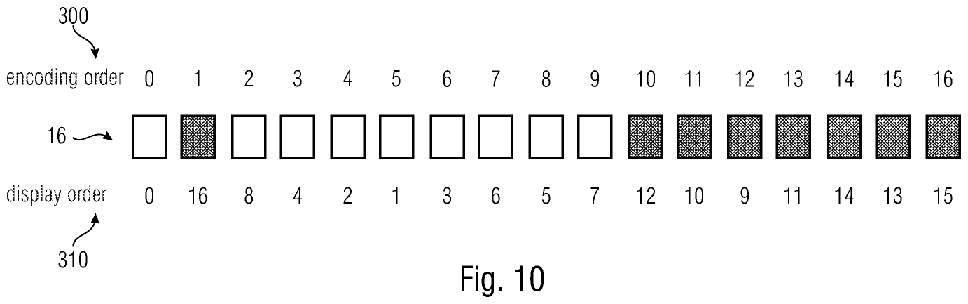

To update the RC statistical model and the corresponding parameters 162 for the new scene 154, necessary data needs to be gathered by means of analysis or encoding. Once the necessary data is collected, said statistical model can be updated for said newly detected scene 154. Updating the RC statistical model after a detected scene change or camera switch 152 is relatively straightforward for the configurations with identical encoding and the display order of the frames 10 in a sequence 16. When encoding a sequence 16 in a configuration where the encoding order 300 is different from the display order 310 of frames 10, such as random-access configuration, some frames 10 may be encoded before the frames which precede them in display order 310. An example for a difference in encoding 300 and display 310 order for one Group of Pictures (GOP) of size 16 is shown in FIG. 1. Furthermore, the example in FIG. 1 indicates a new scene which starts at frame 9 in display order. All frames belonging to the new scene are marked black. As can be seen in FIG. 10, three frames which are displayed after frame 9 are encoded before frame 9, namely, frames with display-order indices 16, 12, and 10. FIG. 10 shows an encoding 300 and display 310 order for GOP structure of size 16. A new scene 154 denoted with black frames begins at the frame with display order 9.

If a hierarchical coding structure is used, different frames 10 can belong to different temporal levels 210 (or layers) as, for example, shown in FIG. 7. Hence, the RC statistical model and the corresponding parameters 162 that must be updated at the beginning of the new scene 154 should be updated at frames 16, 12, 10, and 9, which belong to four different temporal levels 210. The apparatus 100, shown in FIG. 9, may be configured to group the frames of the sequence 16 of frames, e.g., frames 0 to 16 in FIG. 10 or frames 0 to 32 in FIG. 7, into temporal hierarchy levels 210 and perform the adapting, separately for each scene 154, of the rate control parameter 162 for a frame 10 of the respective scene 154 further dependent on the temporal hierarchy level 210 of the respective frame 10. For example, the apparatus 100 is configured to perform the adapting of the rate control parameter 162 for the respective frame 10 individually for each temporal hierarchy level 210 (or temporal layer, or temporal coding level) with which the respective frame is associated, depending on the characteristic of the encoded version of only those frames, e.g., which precede the frame in coding order and are associated with the respective scene, associated with the same temporal hierarchy level.

For example, in display order, for the sequence shown in FIG. 10 the frames 0 and 16 may be associated with a first temporal level 210, frame 8 may be associated with a second temporal level 210, frames 4 and 2 may be associated with a third temporal level 210, frames 2, 6, 10 and 14 may be associated with a fourth temporal level 210 and frames 1, 3, 5, 7, 9, 11, 13 und 15 may be associated with a fifth temporal level 210. The apparatus 100 may be configured to set the rate control parameter 162 to a predetermined setting for all frames of a scene, which are first encountered in encoding order and which are associated with a new temporal level. For the scene 154 indicated by black frames in FIG. 10 the apparatus 100 may be configured to set the rate control parameter 162 associated with frame 16 to a first predetermined setting, the rate control parameter 162 associated with frame 12 to a second predetermined setting, the rate control parameter 162 associated with frame 10 to a third predetermined setting and the rate control parameter 162 associated with frame 9 to a fourth predetermined setting, since frames 9, 10, 12 and 16 are associated with different temporal layers 210. The rate control parameter 162 may be adapted by the apparatus 100 within a scene 154 and within a temporal level 210. Therefore, the rate control parameter 162 associated with frame 11 may be adapted based on characteristics of frame 9, the rate control parameter 162 associated with frame 14 may be adapted based on characteristics of frame 10, the rate control parameter 162 associated with frame 13 may be adapted based on characteristics of frames 9 and 11 and the rate control parameter 162 associated with frame 15 may be adapted based on characteristics of frames 9, 11 and 13.

To decide the frame location (index) at which the RC statistical model parameters have to be updated, frames 10 should be analyzed (evaluated) in display order 310. The first frame of each temporal level occurring after the frame where the scene change or camera switch 152 happens (in display order) is the frame that should use the updated RC statistical model and its corresponding parameters 162. The process of estimating the parameters 162 of the RC statistical model for the new scene 154 depends on the statistical model that is used by the RC. To summarize, if a scene or camera change 152 is detected at frame f, the advantageous embodiment of the improved update of the RC statistical model in the temporal vicinity of said scene or camera change 152 involves two steps:
1. Evaluation of RC model parameters 162, in display order instead of encoding order, for frames already available but not yet encoded, if used by the applied encoding technology (e.g. random access),
2. Update of the RC model parameters 162 using estimations, depending on the frames of the new scene 154, for the first frame f′ in each temporal level (or temporal layer) having display-order location f′≥f.

The following section will describe some method working parallel to the above described apparatuses:

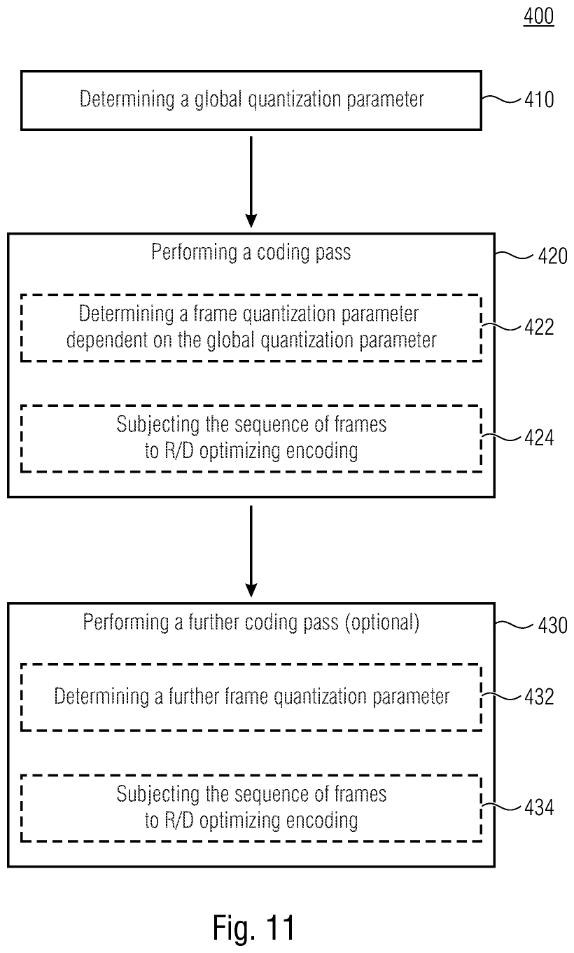

FIG. 11 shows a method 400 for encoding a video having a sequence of frames using rate control, comprising determining 410 a global quantization parameter for the sequence of frames, e.g., based on a target bit-rate. Additionally, the method 400 comprises performing 420 a coding pass, coding the sequence of frames, using the global quantization parameter by determining 422 a frame quantization parameter per frame of the sequence of frames on the basis of the global quantization parameter, and subjecting 424 the sequence of frames to R/D optimizing encoding by using, for each frame, the frame quantization parameter determined for the respective frame so as to obtain an encoded version of an associated coding size for the respective frame. Optionally, the method 400 comprises performing 430 a further coding pass by determining 432, for each frame of the sequence of frames, a further frame quantization parameter based on the frame quantization parameter determined for the respective frame, and the coding size of the respective frame obtained by the coding pass. Additionally, the method 400 may perform 430 the further coding pass by subjecting 434 the sequence of frames to a further R/D optimizing encoding by using, for each frame, the further frame quantization parameter determined for the respective frame, thereby obtaining a coded data stream having the video encoded thereinto.

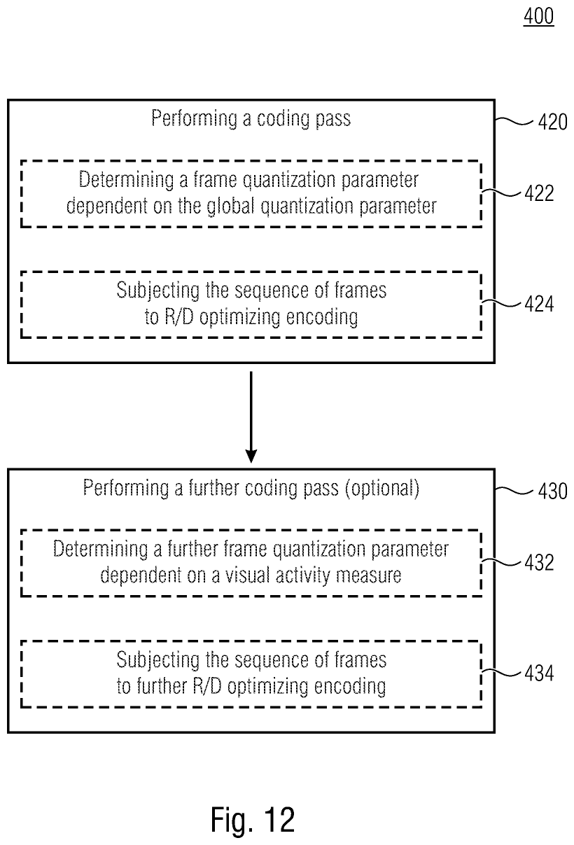

FIG. 12 shows a method 400 for encoding a video having a sequence of frames using rate control, comprising performing 420 a coding pass, coding the sequence of frames, by determining 422 a frame quantization parameter per frame of the sequence of frames, and by subjecting 424 the sequence of frames to R/D optimizing encoding by using, for each frame, the frame quantization parameter determined for the respective frame so as to obtain an encoded version of an associated coding size for the respective frame. Furthermore, the method 400 comprises performing 430 a further coding pass by determining 432, for each frame of the sequence of frames, dependent on a visual activity measure of the respective frame, a further frame quantization parameter based on the frame quantization parameter determined for the respective frame, and the coding size of the respective frame obtained by the coding pass. Additionally, the method 400 may perform 430 the further coding pass by subjecting 434 the sequence of frames to a further R/D optimizing encoding by using, for each frame, the further frame quantization parameter determined for the respective frame, thereby obtaining a coded data stream having the video encoded thereinto.

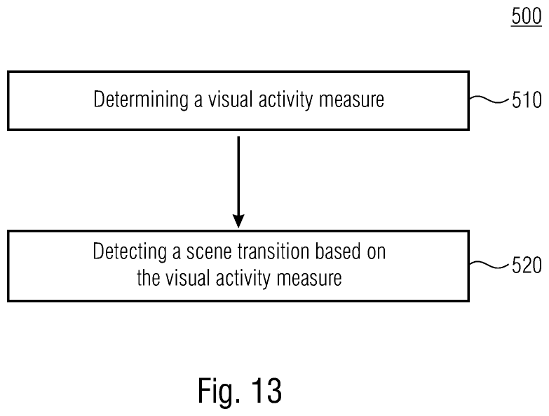

FIG. 13 shows a method 500 for detecting a scene transition in a sequence of frames, comprising determining 510, for each frame of the sequence of frames, a visual activity measure; and detecting the scene transition based on the visual activity measure.

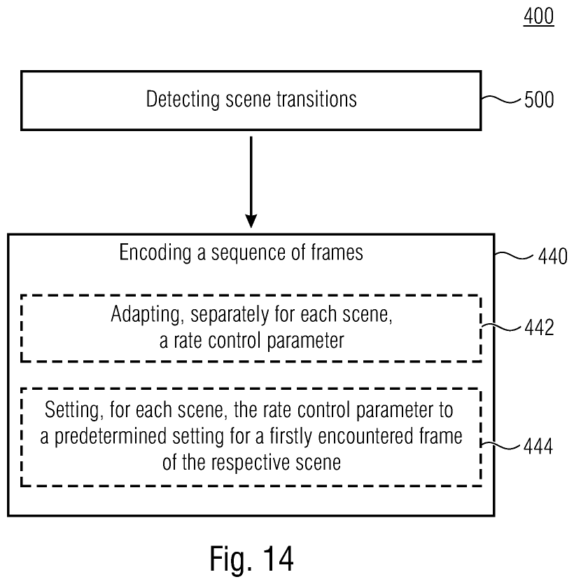

FIG. 14 shows a method 400 for encoding a video using rate control, comprising detecting 500 scene transitions between a number of scenes in a sequence of frames, so that each frame of the sequence of frames is associated with a scene of the number of scenes. Additionally, the method 400 comprises encoding 440 the sequence of frames using rate control by adapting 442, separately for each scene, a rate control parameter for a frame of the respective scene depending on a characteristic of an encoded version of frames which precede the frame in coding order and are associated with the respective scene, and by setting 444, for each scene, the rate control parameter to a predetermined setting for a firstly encountered frame of the respective scene.

General Remarks

Note that, in all of the abovementioned descriptions and proposals, the terms “frame”, “picture”, “slice”, and “image” may be used interchangeably: a frame usually describes a collection of one or more pictures which, in turn, may also be known as an image, and a slice may cover the entirety or a subset of the same. Note, also, that chroma-component data may be used instead of, or in addition to, luma data, e.g., in (4).

Further Remarks:

Above, different inventive embodiments and aspects have been described in a chapter “Alternative QP/Lambda-from-Rate Estimation”, in a chapter “Perceptually Motivated Improvement of Alternative Estimation”, in a chapter “Improved Detection of Scene Changes or Camera Switches” and in a chapter “Improved update of RC statistical model after scene changes/camera switches”.

Also, further embodiments will be defined by the enclosed claims.

It should be noted that any embodiments as defined by the claims can be supplemented by any of the details (features and functionalities) described in the above mentioned chapters.

Also, the embodiments described in the above mentioned chapters can be used individually, and can also be supplemented by any of the features in another chapter, or by any feature included in the claims.

Also, it should be noted that individual aspects described herein can be used individually or in combination. Thus, details can be added to each of said individual aspects without adding details to another one of said aspects.

It should also be noted that the present disclosure describes, explicitly or implicitly, features usable in video encoder (apparatus for providing an encoded representation of an input video signal). Thus, any of the features described herein can be used in the context of a video encoder.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities descrbed herein can be implemented in hardware or in software, or using a combination of hardware and software, as will be described in the section “implementation alternatives”.

Implementation Alternatives:

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] I. Zupancic, M. Naccari, M. Mrak, and E. Izquierdo, “Two-Pass Rate Control for Improved Quality of Experience in UHDTV Delivery,” IEEE J. Sel. Topics in Sig. Process., vol. 11, no. 1, pp. 167ff., February 2017. Online: httpsJfieeexplore.ieee.org/document/7763840
[2] B. Bross, J. Chen, J.-R. Ohm, G. J. Sullivan, and Y.-K. Wang, “Developments in International Video Coding Standardization after AVC, With an Overview of Versatile Video Coding (VVC),” Proc. IEEE, January 2021. Online: https://ieeexplore.ieee.org/document/9328514
[3] Fraunhofer HHI, “Fraunhofer Versatile Video Encoder (VVenC),” version 0.3, repository, 2021. Online: https:J/github.com/fraunhoferhhi/vvenc
[4] G. Cao, X. Pan, Y. Zhou, Y. Li, and Z. Chen, “Two-Pass Rate Control for Constant Quality in High Effi-ciency Video Coding,” in Proc. IEEE VCIP, December 2018. https://ieeexplore.ieee.org/document/8698613
[5] Y. Li, Z. Liu, Z. Chen, and S. Liu, “Rate Control for Versatile Video Coding,” in Proc. IEEE ICIP, October 2020. Online: https://ieeexplore.ieee.org/document/9191125
[6] H. Yuan, Q. Wang, Q. Liu, J. Huo, and P. Li, “Hybrid Distortion-Based Rate-Distortion Optimization and Rate Control for H.265/HEVC,” IEEE Trans. Cons. Electr., DOI 10.1109/TCE.2021.3065636, March 2021. Online: https:/ieeexplore.ieee.org/document/9377475
[7] C. R. Helmrich, S. Bosse, H. Schwarz, D. Marpe, and T. Wiegand, “A Study of the Extended Perceptually Weighted Peak Signal-To-Noise Ratio (XPSNR) for Video Compression with Different Resolutions and Bit Depths,” ITU Journal: ICT Discoveries, vol. 3, no. 1, May 2020. Online: http://handle.itu.int/11.1002/pub/8153d78b-en
[8] B. Li, H. Li, L. Li, and J. Zhang, “Lambda-Domain Rate Control Algorithm for High Efficiency Video Coding,” IEEE Transactions on Image Processing, vol. 23, no. 9, pp. 3841ff., September 2014. Online: https://ieeexplore.ieee.org/document/6849994
[9] L. Li, B. Li, H. Li, and C. W. Chen, “Lambda-Domain Optimal Bit Allocation Algorithm for High Efficiency Video Coding,” IEEE Trans. Circuits Syst. Video Technol., vol. 28, no. 1, pp. 130ff., January 2018. Online: https://ieeexplore.ieee.org/document/7539394
[10] Fraunhofer HHI (C. Helmrich et al.), patent PCT/EP2018/075528, “Concept for Varying a Coding Quantization Parameter Across a Picture, Coding Quantization Parameter Adjustment, and Coding Quantization Parameter Adaptation of a Multi-Channel Picture,” September 2018.
[11] Fraunhofer HHI (C. Helmrich et al.), patent PCT/EP2020/079231, “Apparatus and Method for Improved Video Quality Assessment,” October 2020.
[12] C. R. Helmrich, S. Bosse, M. Siekmann, H. Schwarz, D. Marpe, and T. Wiegand, “Perceptually Optimized Bit Allocation and Associated Distortion Measure for Block-Based Image or Video Coding,” in Proc. IEEE DCC, Snowbird, UT, pp. 172ff., March 2019. Online: https://ieeexplore.ieee.org/document/8712674

1. An apparatus for encoding a video comprising a sequence of frames using rate control, configured to
determine a global quantization parameter for the sequence of frames based on a target bit-rate;
perform a coding pass, coding the sequence of frames, using the global quantization parameter by
determining a frame quantization parameter per frame of the sequence of frames on the basis of the global quantization parameter, and
subjecting the sequence of frames to R/D optimizing encoding by using, for each frame, the frame quantization parameter determined for the respective frame so as to acquire an encoded version of an associated coding size for the respective frame.

2. The apparatus according to claim 1, configured to perform a further coding pass by
determining, for each frame of the sequence of frames, a further frame quantization parameter based on
the frame quantization parameter determined for the respective frame,
and
the coding size of the respective frame acquired by the coding pass;
and
subjecting the sequence of frames to a further R/D optimizing encoding by using, for each frame, the further frame quantization parameter determined for the respective frame, thereby acquiring a coded data stream having the video encoded thereinto.

3. The apparatus according to claim 1, wherein the R/D optimizing encoding is performed without rate control.

4. The apparatus according to claim 1, wherein the further R/D optimizing encoding is performed, for each frame of the sequence of frames, in a single loop using rate control so that each frame is encoded according to the target bit rate by determining, for each block of the respective frame, depending on the target bit-rate, a block quantization parameter out of a set of block quantization parameters, which set is determined by the further frame quantization parameter.

5. The apparatus according to claim 1, wherein the apparatus is configured to determine the global quantization parameter for the sequence of frames further based on a width and height of the frames of the sequence of frames.

6. The apparatus according to claim 1, wherein, for each frame, the coding size associated with the encoded version for the respective frame corresponds to a number of bits associated with the encoded version for the respective frame.

7. The apparatus according to claim 1, configured to perform, for each frame of the sequence of frames, the determining of the further frame quantization parameter depending on a deviation between a target coding size of the respective frame associated with the target bit rate and the coding size of the respective frame acquired by the coding pass.

8. The apparatus according to claim 7, configured to perform, for each frame of the sequence of frames, the determining of the further frame quantization parameter depending on the deviation between the target coding size of the respective frame and the coding size of the respective frame acquired by the coding pass such that the further frame quantization parameter is associated with a coarser quantization than the frame quantization parameter in case of the coding size being larger than the target coding size and the further frame quantization parameter is associated with a finer quantization than the frame quantization parameter in case of the coding size being smaller than the target coding size.

9. The apparatus according to claim 7, configured to perform, for each frame of the sequence of frames, the determining of the further frame quantization parameter according to a further determination function of the deviation between the target coding size of the respective frame and the coding size and to adapt the further determination function during the further coding pass according to a previously encoded frame.

10. The apparatus according to claim 7, configured to perform, for each frame of the sequence of frames, the determining of the further frame quantization parameter according to a further determination function of the deviation between the target coding size of the respective frame and the coding size and to adapt the further determination function for the respective frame according to a previously encoded frame of a temporal hierarchy level equal to a temporal hierarchy level of the respective frame.

11. The apparatus according to claim 7, configured to perform, for each frame of the sequence of frames, the determining of the further frame quantization parameter according to a further determination function of the deviation between the target coding size of the respective frame and the coding size and to adapt the further determination function for the respective frame according to a deviation between an even further coding size resulting from the further RD optimizing encoding for the previously encoded frame on the one hand and the target coding size or the coding size of the previously encoded frame on the other hand.

12. The apparatus according to claim 1, configured to perform, for each frame of the sequence of frames, the determining of the frame quantization parameter for each frame of the sequence of frames on the basis of the global quantization parameter depending on a frame coding type and/or a temporal hierarchy level of the respective frame.

13. The apparatus according to claim 1, configured to further, for each frame of the sequence of frames, determine a Lagrange parameter for each frame of the sequence of frames on the basis of the global quantization parameter or depending on the frame quantization parameter determined for the respective frame, and to perform R/D optimizing encoding of the respective frame further using the Lagrange parameter determined for the respective frame.

14. The apparatus according to claim 1, configured to further, for each frame of the sequence of frames, determine a further Lagrange parameter for each frame of the sequence of frames depending on the further frame quantization parameter determined for the respective frame, and to perform the further R/D optimizing encoding of the respective frame further using the further Lagrange parameter determined for the respective frame.

15. The apparatus according to claim 14, configured to determine the further Lagrange parameter for each frame of the sequence of frames depending on the further frame quantization parameter determined for the respective frame further depending on
the frame quantization parameter determined for the respective frame,
and
the Lagrange parameter determined for the respective frame.

16. The apparatus according to claim 14, configured to determine the further Lagrange parameter λ_{f} for each frame of the sequence of frames according to
λ_{f}=λ′_{f}·2^{(QP}^{_{f}}^{-QP′}^{_{f}}^{)/3},
wherein
λ′_{f} is the frame Lagrange parameter determined for the respective frame,
QP_{f} is the further frame quantization parameter determined for the respective frame, and
QP′_{f} is the frame quantization parameter determined for the respective frame.

17. The apparatus according to claim 1, wherein the apparatus is configured to perform the further coding pass by
allocating, for each frame of the sequence of frames, a target coding size to the respective frame, and
performing, for each frame of the sequence of frames, the determining of the further frame quantization parameter further based on the target coding size of the respective frame.

18. The apparatus according to claim 17, wherein, for each frame, the target coding size allocated to the respective frame corresponds to a number of bits allocated to the respective frame.

19. The apparatus according to claim 1, configured to perform, for each frame of the sequence of frames, the determining of the further frame quantization parameter QP_{f} using a further determination function being defined by
QP_{f}=Clip3(QPₘᵢₙ,QPₘₐₓ,round(QP′_{f}−a·log₁₀(B_{f}/B′_{f})))
or
QP_{f}=Clip3(QPₘᵢₙ,QPₘₐₓ,round(QP′_{f}+a·log₁₀(B′_{f}/B_{f}))),
wherein
QPₘᵢₙ is a first predetermined constant,
QPₘₐₓ is a second predetermined constant,
the operator Clip3 ( . . . ) enforces the range QPₘᵢₙ≤QP_{f}≤QPₘₐₓ on a value of the further frame quantization parameter QP_{f},
QP′_{f} is the frame quantization parameter of the respective frame determined for the coding pass,
a is a parameter dependent on the frame quantization parameter QP′_{f},
B_{f} is a target coding size for the respective frame, and
B′_{f} is the coding size of the respective frame acquired by the coding pass.

20. An apparatus for detecting a scene transition in a sequence of frames, configured to determine, for each frame of the sequence of frames, a visual activity measure; and
detect the scene transition based on the visual activity measure.

21. The apparatus according to claim 20, wherein the visual activity measure corresponds to a measure of dispersion of a statistical sample value distribution of a high-pass filtered version of the respective frame.

22. The apparatus according to claim 20, wherein the visual activity measure is associated with a luma-component of the respective frame.

23. The apparatus according to claim 20, configured to detect the scene transition at a current frame based on the visual activity measure associated with the current frame and on the visual activity measure associated with a preceding frame.

24. The apparatus according to claim 20, configured to detect the scene transition at the current frame based on a quotient of a division between a dividend derived by the visual activity measure associated with the current frame and a divisor derived by the visual activity measure associated with a preceding frame.

25. The apparatus according to claim 24, configured to detect the scene transition in case of the quotient exceeding a threshold.

26. The apparatus according to claim 23, configured to detect the scene transition in case of the visual activity measure associated with the current frame exceeding the visual activity measure associated with a preceding frame multiplied with a predetermined value.

27. The apparatus according to claim 20,
wherein a scene is associated with a predetermined duration, and
wherein the apparatus is configured to suppress a detection of a scene transition at a current frame, if the current frame occurs during the predetermined duration.

28. The apparatus according to claim 27, wherein the predetermined duration is defined by a minimum number of frames.

29. The apparatus according to claim 27, wherein the predetermined duration depends on a frame rate of the sequence of frames.

30. The apparatus according to claim 20 configured to
perform the detection of the scene transitions between a number of scenes in a sequence of frames, so that each frame of the sequence of frames is associated with a scene of the number of scenes;
and signal scene information to an apparatus for encoding a video using rate control, so that the apparatus for encoding a video is enabled to use the scene transitions so as to
encode the sequence of frames using rate control by
adapting, separately for each scene, a rate control parameter for a frame of the respective scene depending on a characteristic of an encoded version of frames which precede the frame in coding order and are associated with the respective scene, and
setting, for each scene, the rate control parameter to a predetermined setting for a firstly encountered frame of the respective scene.

31. The apparatus according to claim 30, wherein the apparatus for encoding is configured to
group the frames of the sequence of frames into temporal hierarchy levels; and
perform the adapting, separately for each scene, of the rate control parameter for a frame of the respective scene further dependent on the temporal hierarchy level of the respective frame.

32. The apparatus according to claim 30, wherein the predetermined setting is a default setting.

33. The apparatus according to claim 30, wherein the apparatus for encoding is configured to derive the predetermined setting by
evaluating one or more frames of the respective scene, which one or more frames are already available but not yet encoded, so as to acquire an evaluation result, and
deriving the predetermined setting based on the evaluation result.

34. The apparatus according to claim 33, wherein the apparatus for encoding is configured to perform the evaluating one or more frames of the respective scene based on an analysis of the visual activity measure of these one or more frames.

35. The apparatus according to claim 30, wherein the apparatus for encoding is configured to
perform the encoding of the sequence of frames using rate control by
performing a coding pass, coding the sequence of frames, by
determining a frame encoding parameter per frame of the sequence of frames, and
subjecting the sequence of frames to R/D optimizing encoding by using, for each frame, the frame encoding parameter determined for the respective frame so as to acquire an encoded version of an associated coding size for the respective frame;
and
performing a further coding pass by
determining, for each frame of the sequence of frames, using a determination function, a further frame encoding parameter based on
the frame encoding parameter determined for the respective frame, and
the coding size of the respective frame acquired by the coding pass;
and
subjecting the sequence of frames to a further R/D optimizing encoding by using, for each frame, the further frame encoding parameter determined for the respective frame, thereby acquiring a coded data stream having the video encoded thereinto,
and
performing the adapting, separately for each scene, of the rate control parameter for the frame of the respective scene by adapting the determination function, depending on the characteristic of the encoded version of frames which precede the frame in coding order and are associated with the respective scene.

36. The apparatus according to claim 35, wherein the determining, for each frame of the sequence of frames, of the further frame encoding parameter using the determination function, is performed dependent on a visual activity measure of the respective frame.

37. The apparatus according to claim 30, wherein the apparatus for encoding is configured to perform, for each frame of the sequence of frames, the determining of the further frame quantization parameter depending on a deviation between a target coding size of the respective frame associated with a target bit rate and the coding size of the respective frame acquired by the coding pass.

38. The apparatus according to claim 37, wherein the apparatus for encoding is configured to perform, for each frame of the sequence of frames, the determining of the further frame quantization parameter according to a further determination function of the deviation between the target coding size of the respective frame and the coding size and to adapt the further determination function for the respective frame according to a previously encoded frame.

39. The apparatus according to claim 37, wherein the apparatus for encoding is configured to perform, for each frame of the sequence of frames, the determining of the further frame quantization parameter according to a further determination function of the deviation between the target coding size of the respective frame and the coding size and to adapt the further determination function for the respective frame according to a previously encoded frame of a temporal hierarchy level equal to a temporal hierarchy level of the respective frame

40. The apparatus according to claim 37, wherein the apparatus for encoding is configured to perform, for each frame of the sequence of frames, the determining of the further frame quantization parameter according to a further determination function of the deviation between the target coding size of the respective frame and the coding size and to adapt the further determination function for the respective frame according to a deviation between an even further coding size resulting from the further RD optimizing encoding for the previously encoded frame on the one hand and the target coding size or the coding size of the previously encoded frame on the other hand.

41. A method for encoding a video comprising a sequence of frames using rate control, comprising
determining a global quantization parameter for the sequence of frames based on a target bit-rate;
performing a coding pass, coding the sequence of frames, using the global quantization parameter by
determining a frame quantization parameter per frame of the sequence of frames on the basis of the global quantization parameter, and
subjecting the sequence of frames to R/D optimizing encoding by using, for each frame, the frame quantization parameter determined for the respective frame so as to acquire an encoded version of an associated coding size for the respective frame.

42. A method for detecting a scene transition in a sequence of frames, comprising determining, for each frame of the sequence of frames, a visual activity measure; and
detecting the scene transition based on the visual activity measure.

43. A non-transitory digital storage medium having stored thereon a computer program for performing a method for encoding a video comprising a sequence of frames using rate control, comprising:
determining a global quantization parameter for the sequence of frames based on a target bit-rate;
performing a coding pass, coding the sequence of frames, using the global quantization parameter by
determining a frame quantization parameter per frame of the sequence of frames on the basis of the global quantization parameter, and
subjecting the sequence of frames to R/D optimizing encoding by using, for each frame, the frame quantization parameter determined for the respective frame so as to acquire an encoded version of an associated coding size for the respective frame,
when the computer program is run by a computer.

44. A non-transitory digital storage medium having stored thereon a computer program for performing a method for detecting a scene transition in a sequence of frames, comprising
determining, for each frame of the sequence of frames, a visual activity measure; and
detecting the scene transition based on the visual activity measure,
when the computer program is run by a computer.

45. A data stream generated by an apparatus according to claim 1.
